(19) United States
(12) Patent Application Publication
(10) Pub. No.: US 2017/0185218 A1
(43) Pub. Date: Jun. 29, 2017

(54) TOUCH CONTROLLER, TOUCH SENSING DEVICE, AND TOUCH SENSING METHOD

(71) Applicant: SAMSUNG ELECTRONICS CO., LTD., SUWON-SI (KR)

(72) Inventors: JIN-CHUL LEE, SEOUL (KR); YOON-KYUNG CHOI, SEOUL (KR); JIN-BONG KIM, YONGIN-SI (KR); BUM-SOO KIM, SEOUL (KR); JUN-CHUL PARK, DAEGU (KR)

(21) Appl. No.: 15/392,253

(22) Filed: Dec. 28, 2016

(30) Foreign Application Priority Data
Dec. 29, 2015 (KR) 10-2015-0188907
Jun. 2, 2016 (KR) 10-2016-0068844

(51) Int. Cl. G06F 3/041; G06F 3/044

(52) U.S. Cl. CPC G06F 3/0416; G06F 3/044

(57) ABSTRACT

A touch controller is provided. The touch controller includes a driving circuit configured to mask some pulses of a first pulse signal having a certain frequency to generate a second pulse signal, and supply the second pulse signal to a touch panel as a driving signal and a sensing circuit configured to receive a sensing signal generated by the touch panel based on the driving signal and generate touch data, based on the sensing signal.

### CROSS-REFERENCE TO RELATED APPLICATIONS

This application claims priority under 35 U.S.C. §119 to Korean Patent Application No. 10-2015-0188907, filed on Dec. 29, 2015, and Korean Patent Application No. 10-2016-0068844, filed on Jun. 2, 2016, in the Korean Intellectual Property Office, the disclosures of which are incorporated by reference in their entireties herein.

### BACKGROUND

1. Technical Field

The inventive concept relates to a touch sensing system, and more particularly, to a touch controller, a touch sensing device including the same, and a touch sensing method.

2. Discussion of Related Art

Touch sensing devices are input devices that enable a user to apply a user input by using a hand or an object such as a touch pen in response to content displayed on a screen of a display device. A touch sensing device may be disposed on a front surface of the display device. The touch sensing device may generate an electrical signal corresponding to a touched position on the front surface. An electronic apparatus, including the display device, such as a portable phone, a laptop computer, a desktop computer, or a personal digital assistant (PDA), may recognize the touched position, based on the generated electrical signal and may analyze the touched position to perform a corresponding operation.

A touch sensing device typically includes a touch panel for receiving the touches and a touch controller for controlling the touch panel. The touch controller applies a driving signal to the touch panel. However, the driving signal may generate electromagnetic interference, thereby reducing quality of the display device. Thus, there is a need for touch sensing devices that reduce or prevent electromagnetic interference.

### SUMMARY

At least one embodiment of the inventive concept provides a touch controller, a touch sensing device including the same, and a touch sensing method, in which electromagnetic interference (EMI) is greatly reduced when driving a touch panel. Accordingly, the image quality of a display panel may be increased and a chip size of the display panel may be reduced.

According to an exemplary embodiment of the inventive concept, there is provided a touch controller including a driving circuit configured to mask some pulses of a first pulse signal having a certain frequency to generate a second pulse signal, and supply the second pulse signal to a touch panel as a driving signal and a sensing circuit configured to receive a sensing signal generated based on the driving signal by the touch panel and generate touch data, based on the sensing signal.

According to an exemplary embodiment of the inventive concept, there is provided a touch sensing device including a driving circuit including a plurality of channels for sensing a touch input and a touch controller configured to mask some pulses of a periodic pulse signal having a certain frequency to generate a driving signal applied to the plurality of channels, and sense a capacitance variation rate of each of a plurality of sensing nodes respectively connected to the plurality of channels.

According to an exemplary embodiment of the inventive concept, there is provided a touch sensing method performed by a touch controller connected to a touch panel including a plurality of driving channels, the touch sensing method including generating a periodic pulse signal, based on a certain frequency, masking some pulses of the periodic pulse signal to generate a driving signal, based on masking information, supplying the driving signal to at least one of the plurality of driving channels, and sensing a capacitance variation rate of a sensing node connected to a corresponding one of the driving channels, based on the driving signal.

According to an exemplary embodiment of the inventive concept, there is provided a touch screen device including a display panel, a touch panel, a driving circuit, and a sensing circuit. The driving circuit is configured to mask a part of a periodic pulse signal during a period of the display panel and drive the touch panel using the masked periodic pulse signal, and a sensing circuit configured to receive a sensing signal generated by the touch panel based on the masked signal and generate touch data based on the sensing signal.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a touch sensing device according to an exemplary embodiment of the inventive concept;

FIG. 2 is a diagram illustrating a sensing array according to an exemplary embodiment of the inventive concept;

FIG. 3 is a timing diagram showing pulse signals according to an embodiment of the inventive concept;

FIG. 4 is a diagram showing exemplary frequency responses of pulse signals of FIG. 3;

FIGS. 5A and 5B are diagrams for describing a capacitance variation of a sensing node based on a touch input;

FIG. 6 is a graph for describing a capacitance variation rate of a sensing node based on a touch input;

FIG. 7 is a diagram schematically illustrating a driving circuit according to an exemplary embodiment of the inventive concept;

FIGS. 8A and 8B are timing diagrams showing a driving signal supplied to row channels based on a driving method of a driving circuit according to an exemplary embodiment of the inventive concept;

FIG. 9 is a block diagram illustrating an implementation example of a driving circuit according to an exemplary embodiment of the inventive concept;

FIGS. 10A and 10B are timing diagrams of the driving circuit of FIG. 9;

FIG. 11A is a diagram illustrating a driving method of a driving circuit according to an exemplary embodiment of the inventive concept;

FIG. 11B is a timing diagram of a touch panel and a touch circuit based on the driving method of the driving circuit of FIG. 11A;

FIG. 12 is a block diagram illustrating an implementation example of a driving circuit according to an exemplary embodiment of the inventive concept;

FIG. 13 is a timing diagram of the driving circuit of FIG. 12;

FIG. 14 is a block diagram illustrating a driving circuit according to an exemplary embodiment of the inventive concept;

FIG. 15 is a diagram for describing a multi-driving method of a touch controller according to an exemplary embodiment of the inventive concept;

FIG. 16 is a diagram for describing a multi-driving method of a touch controller according to an exemplary embodiment of the inventive concept;

FIG. 17 is a block diagram illustrating an implementation example of a control logic according to an exemplary embodiment of the inventive concept;

FIG. 18 is a block diagram schematically illustrating a sensing circuit according to an exemplary embodiment of the inventive concept;

FIG. 19 is a diagram illustrating a touch panel and a display panel included in a touch sensing device according to an exemplary embodiment of the inventive concept;

FIG. 20 is a timing diagram of a driving circuit according to an exemplary embodiment of the inventive concept;

FIG. 21 is a flowchart illustrating a touch sensing method according to an exemplary embodiment of the inventive concept;

FIG. 22 is a flowchart illustrating an operation of generating a driving signal and an operation of supplying the driving signal to a driving channel illustrated in FIG. 21, according to an exemplary embodiment of the inventive concept;

FIG. 23 is a flowchart illustrating an operation of generating a driving signal and an operation of supplying the driving signal to a driving channel illustrated in FIG. 21, according to an exemplary embodiment of the inventive concept;

FIG. 24 is a block diagram illustrating a touch screen device including a touch controller according to an exemplary embodiment of the inventive concept;

FIG. 25 is a block diagram illustrating a touch screen system according to an exemplary embodiment of the inventive concept;

FIG. 26 is a diagram illustrating a touch screen module including a touch sensing device according to an exemplary embodiment of the inventive concept; and

FIG. 27 is a diagram illustrating an application example of various electronic devices each including a touch sensing device according to an exemplary embodiment of the inventive concept.

### DETAILED DESCRIPTION OF THE EMBODIMENTS

Hereinafter, exemplary embodiments of the inventive concept will be described with reference to the accompanying drawings.

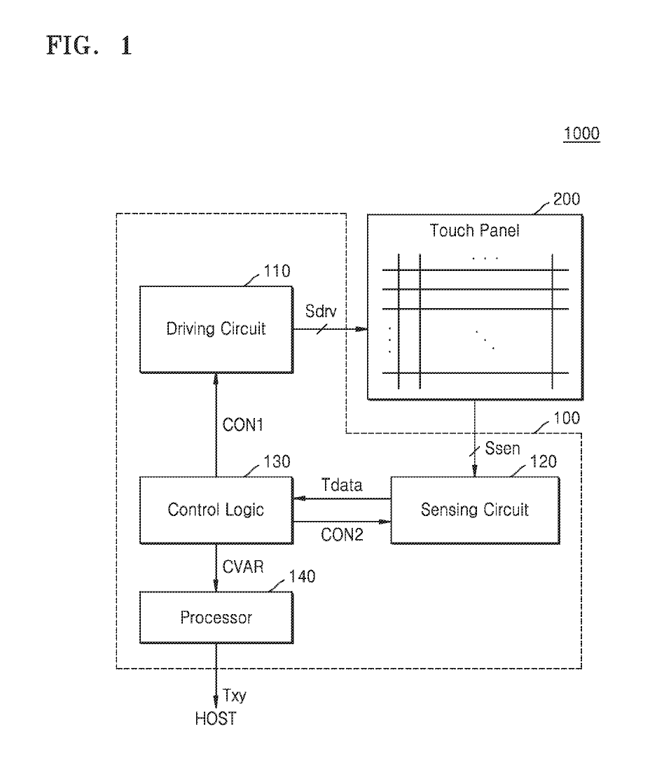

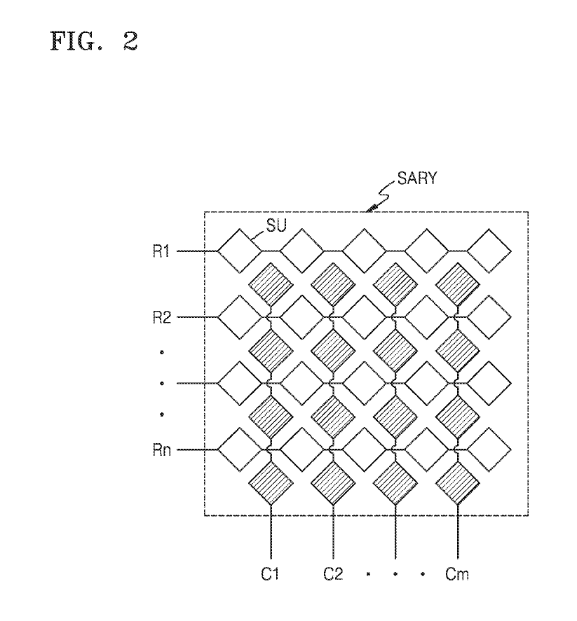

FIG. 1 is a block diagram illustrating a touch sensing device 1000 according to an embodiment, and FIG. 2 is a diagram illustrating a sensing array according to an exemplary embodiment of the inventive concept.

Referring to FIG. 1, the touch sensing device 1000 includes a touch panel 200 and a touch controller 100. The touch sensing device 1000 may be installed in electronic devices providing an image display function. The electronic devices may denote personal computers (PCs) or mobile devices, but are not limited thereto. Examples of the mobile devices may include laptop computers, mobile phones, smartphones, tablet PCs, personal digital assistants (PDAs), enterprise digital assistants (EDAs), digital still cameras, digital video cameras, portable multimedia players (PMPs), personal navigation devices, portable navigation devices (PNDs), handheld game consoles, mobile internet devices (MIDs), internet of things (IoT), internet of everything (IoE), drones, e-books, etc., but are not limited thereto.

The touch panel 200 generates a sensing signal Ssen corresponding to a touch input and supplies the sensing signal Ssen to the touch controller 100. In this case, the touch input may include, for example, a case where a conductor such a finger or the like approaches the touch panel 200, in addition to a case where the conductor directly contacts the touch panel 200.

The touch panel 200 may include a sensing array SARY. As illustrated in FIG. 2, the sensing array SARY includes a plurality of row channels R1 to Rn, which are arranged in a first direction, and a plurality of column channels C1 to Cm which are arranged in a second direction intersecting the first direction. For example, the first direction may be vertical to or substantially vertical to the second direction. The row channels R1 to Rn and the column channels C1 to Cm each include a plurality of sensing units SU which are electrically connected to each other. In an embodiment, the plurality of sensing units SU are provided as one body for each of the plurality of channels. For example, each row or column of the sensing array SARY may correspond to a distinct connected string of sensing units. In an embodiment, the row channels R1 to Rn are each a drive electrode receiving a driving signal Sdrv, and the column channels C1 to Cm are each a sensing electrode through which the sensing signal Ssen is output. In an embodiment, the row channels R1 to Rn are each the sensing electrode, and the column channels C1 to Cm are each the drive electrode. In an embodiment, the row channels R1 to Rn and the column channels C1 to Cm are the drive electrodes as well as the sensing electrodes.

In an embodiment, the row channels R1 to Rn and the column channels C1 to Cm are disposed on different layers. In an embodiment, the row channels R1 to Rn and the column channels C1 to Cm are disposed on the same layer.

In the present embodiment, the plurality of sensing units SU are capacitive touch sensors, and thus, the touch panel 200 may be referred to as a capacitive touch screen panel. The touch panel 200 may generate the sensing signal, based on a mutual capacitance sensing type or a self-capacitance sensing type. In a mutual capacitance sensing type, an object (e.g., finger or conductive stylus) alters the mutual coupling between row and column electrodes. In a self-capacitance sensing type, the object loads the sensor or increases the parasitic capacitance to ground.

Referring again to FIG. 1, the touch controller 100 is configured to determine whether a touch input is applied to the touch panel 200 and may detect a position to which the touch input is applied. The touch controller 100 includes a driving circuit 110, a sensing circuit 120, control logic 130, and a processor 140. The driving circuit 110 supplies the driving signal Sdrv to a plurality of channels (e.g., the row channels R1 to Rn) included in the touch panel 200, and the sensing circuit 120 receives the sensing signal Ssen from each of other channels (e.g., the column channels C1 to Cm).

The driving circuit 110 generates the driving signal Sdrv, based on a first control signal CON1 output from the control logic 130 and supplies the driving signal Sdrv to the touch panel 200. In an embodiment, the driving circuit 110 sequentially supplies the driving signal Sdrv to a plurality of driving channels (e.g., the row channels R1 to Rn). In an embodiment, the driving circuit 110 simultaneously supplies the driving signal Sdrv to some of the plurality of driving channels. Such a driving method may be referred to as a multi-driving method. For example, the driving circuit 110 may simultaneously supply the driving signal Sdrv in units of a predetermined plurality of driving channels. In this case, different driving signals Sdrv may be respectively supplied to the plurality of driving channels.

The driving signal Sdrv applied to each of the plurality of driving channels may include a plurality of pulses. In the present embodiment, the driving circuit 110 masks some pulses of a first pulse signal having a predetermined frequency to generate a second pulse signal and supplies the second pulse signal as the driving signal Sdrv. In an embodiment, the driving circuit 110 adjusts the number of pulses output as the driving signal Sdrv among pulses of the first pulse signal, based on the predetermined number of pulses. The adjustment may involve suppressing some of the pulses. For example, the suppression may be caused by outputting the first pulse signal to a first input of an AND gate and a control signal to a second input of the AND gate, where the control signal is set to a low level of one of the pulses for as long as masking is required. The second pulse signal is output by the AND gate. In an embodiment, a short stop circuit is operated on the first pulse signal to generate the second pulse signal.

The first pulse signal may be a signal including a plurality of pulses which are repeated according to a certain frequency, and may be referred to as a periodic pulse signal. The second pulse signal may be a signal generated by skipping some pulses of the periodic pulse signal and may be referred to as a skip pulse signal (or a masked periodic pulse signal). Hereinafter, the first pulse signal is referred to as the periodic pulse signal, and the second pulse signal is referred to as the skip pulse signal.

By masking some pulses of the periodic pulse signal, outputs of the some pulses are skipped, and thus, the number of pulses per unit period is reduced. The driving circuit 110 supplies the skip pulse signal, generated by masking some pulses of the periodic pulse signal, to the touch panel 200 as the driving signal Sdrv. The unit period may denote a duration during which the driving signal Sdrv (i.e., pulses) is supplied to one drive electrode. For example, the unit period may be a duration obtained by dividing a duration, during which the driving signal Sdrv is supplied to all drive electrodes, by the number of drive electrodes. In a case where the driving signal Sdrv is applied to a plurality of drive electrodes, the unit period may be a duration obtained by dividing a duration, during which the driving signal Sdrv is applied to the plurality of drive electrodes, by the number of the drive electrodes.

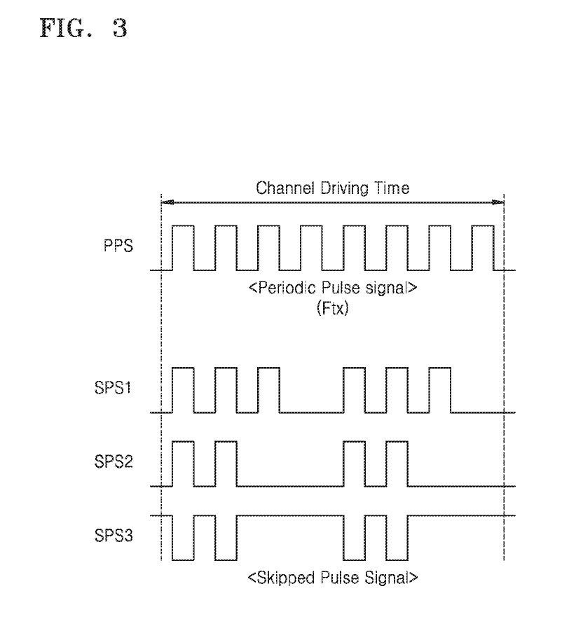

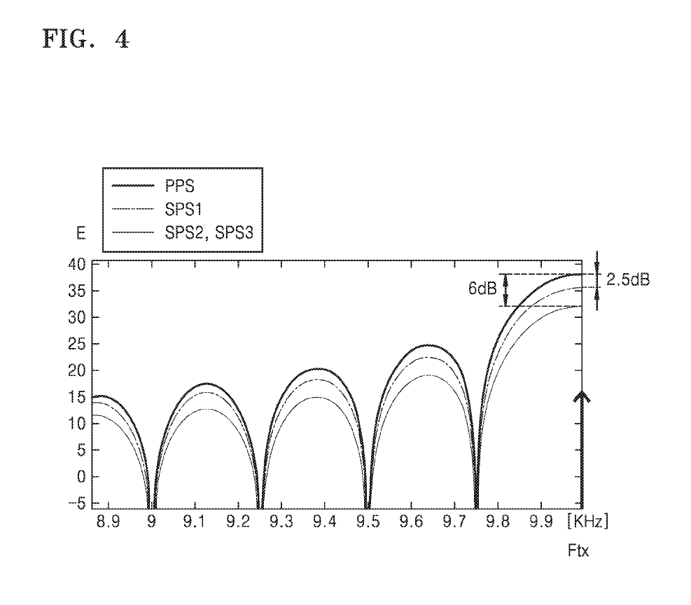

The touch sensing device 1000 may be disposed adjacent to a display apparatus (not shown), or may be implemented as one module along with the display apparatus. When the driving signal Sdrv is supplied to the touch panel 200, electromagnetic interference (EMI) may occur, which may cause the image quality of a display panel to degrade. In an exemplary embodiment of the inventive concept, a level of energy of the driving signal Sdrv is adjusted to reduce the EMI. The driving circuit 110 according to the present embodiment skips outputs of some pulses of the periodic pulse signal to generate the driving signal Sdrv, thereby adjusting the level of the energy of the driving signal Sdrv. This will be described in more detail with reference to FIGS. 3 and 4.

FIG. 3 is a timing diagram showing pulse signals according to an embodiment, and FIG. 4 is a diagram showing exemplary frequency responses of pulse signals of FIG. 3.

Referring to FIG. 3, the driving circuit 110 generates a periodic pulse signal PPS. The periodic pulse signal PPS is a signal having a predetermined frequency (for example, a center frequency is Ftx) and includes a plurality of pulses. For convenience of description, a case where the periodic pulse signal PPS includes eight pulses during a channel driving duration will be described as an example.

In an embodiment of the inventive concept, the driving circuit 110 masks some pulses of the periodic pulse signal PPS to generate a plurality of skip pulse signals SPS1 to SPS3. In an embodiment, the skip pulse signal SPS1 is a signal generated by skipping one-fourth of pulses of the periodic pulse signal PPS. For example, when the periodic pulse signal PPS includes eight pulses during the channel driving ratio, the skip pulse signal SPS1 include six pulses during the channel driving duration when one-fourth of the pulses are masked out. In an embodiment, the skip pulse signal SPS2 is a signal generated by skipping half of the pulses of the periodic pulse signal PPS. For example, when the periodic pulse signal PPS includes eight pulses during the channel driving ratio, the skip pulse signal SPS2 includes four pulses during the channel driving duration when half of the pulses are masked out. In an embodiment, the skip pulse signal SPS3 is a signal which is generated by skipping half of the pulses of the periodic pulse signal PPS and inverting a phase. For example, when the periodic pulse signal PPS includes eight pulses during the channel driving ratio, the skip pulse signal SPS3 includes four pulses during the channel driving duration and has a phase opposite to that of the periodic pulse signal PPS when half of the pulses are masked out and the phase is inverted.

Referring to FIG. 4, the abscissa axis indicates a frequency, and the ordinate axis indicates energy. As shown in FIG. 4, the larger the number of pulses included in a pulse signal, the higher the energy, and the smaller the number of pulses included in the pulse signal, the lower the energy. A center frequency of the skip pulse signal SPS1 generated by skipping one-fourth of the pulses of the periodic pulse signal PPS may be similar to the center frequency Ftx of the periodic pulse signal PPS, and energy may be reduced by −2.5 dB (decibel) in comparison with energy of the periodic pulse signal PPS. A center frequency of each of the skip pulse signals SPS2 and SPS3 generated by skipping a half of the pulses of the periodic pulse signal PPS may be similar to the center frequency Ftx of the periodic pulse signal PPS, and energy may be reduced by −6 dB in comparison with the energy of the periodic pulse signal PPS. Therefore, the driving circuit 110 may mask some of the pulses of the periodic pulse signal PPS without changing a frequency of the periodic pulse signal PPS, and by adjusting the number of the masked pulses, the driving circuit 110 may adjust energy of the driving signal Sdrv.

FIGS. 3 and 4 exemplarily show a relationship between the periodic pulse signal PPS and the skip pulse signals SPS1 to SPS3.

Referring again to FIG. 1, the sensing circuit 120 receives the sensing signal Ssen generated from the touch panel 200 based on the driving signal Sdrv and supplies touch data Tdata to the control logic 130 as a processing result of the received sensing signal Ssen. The sensing circuit 120 operates based on a second control signal CON2 supplied from the control logic 130. The sensing circuit 120 may include at least one of a charge amplifier, an integrator, and an analog-to-digital converter (ADC). Also, the sensing circuit 120 may further include an offset compensation circuit for removing an offset capacitance. In an embodiment, the charge amplifier is an electronic current integrator that produces voltage proportional to an integrated value of an input current.

The control logic 130 may control an overall operation of the touch controller 100 and generates the first control signal CON1 and the second control signal CON2. The control logic 130 may control the driving circuit 110 and the sensing circuit 120, based on the first control signal CON1 and the second control signal CON2. In an embodiment, the first control signal CON1 is a signal for controlling an operation of the driving circuit 110 and may include at least one of frequency information, masking information, and phase information.

The frequency information may be a signal for determining a frequency of the periodic pulse signal and may include a frequency setting signal. The frequency information may include the desired frequency. The masking information may be a signal indicating information about a skipped pulse of the periodic pulse signal, and for example, may be a masking signal (or a masking pattern) indicating a masking period or may be information about the number of pulses which are to be masked in the unit period. The masking information may also indicate a given sequence of the pulses to be skipped during a given period (e.g., first and third, second and fourth, last two pulses, etc.). The number of pulses which are to be masked in the unit period may be set based on EMI which occurs when the driving signal Sdrv is supplied to the touch panel 200.

The phase information may be a phase signal indicating a phase shift level of the driving signal supplied through a certain channel based on a phase of the periodic pulse signal. For example, the phase shift level may be an angle such as 45°, 90°, 135°, 180°, etc. In an embodiment, the control logic 130 analyzes the touch data Tdata and adjusts the masking information or the phase information, based on a result of the analysis.

In an embodiment, the second control signal CON2 is a signal for controlling an operation of the sensing circuit 120 and includes a timing signal indicating a sensing time. The sensing time may indicate how often to sample the sensing array SARY.

In an embodiment, the control logic 130 calculates a capacitance variation rate CVAR of each of a plurality of touch sensing nodes included in the touch panel 200, based on the touch data Tdata supplied from the sensing circuit 120. In an embodiment, the control logic 130 includes a circuit (for example, a digital filter circuit) for removing noise included in the touch data Tdata. The control logic 130 may remove the noise of the touch data Tdata and may supply the capacitance variation rate CVAR of each of the touch sensing nodes to the processor 140, based on the touch data Tdata from which the noise has been removed.

The processor 140 generates touch coordinates Txy indicating a position to which a touch input is applied in the touch panel 200, based on the capacitance variation rate CVAR supplied from the control logic 130. The processor 140 may supply the touch coordinates Txy to a host HOST. In an embodiment, the processor 140 is implemented with a micro control unit (MCU).

As described above, in the touch sensing device 1000 according to an exemplary embodiment of the inventive concept, the driving circuit 110 of the touch controller 100 skips some pulses of the periodic pulse signal PPS having the predetermined frequency to generate the skip pulse signal and supplies the skip pulse signal as the driving signal Sdrv. Therefore, the touch controller 100 may adjust the number of the skipped pulses, thereby adjusting energy of the driving signal Sdrv.

On the other hand, in a case where the periodic pulse signal PPS is supplied to the touch panel 200 as the driving signal Sdrv, a frequency may be adjusted, or a voltage level of the periodic pulse signal PPS may be adjusted, for adjusting the energy of the driving signal Sdrv. In order to maximize sensing performance, an offset value of the sensing circuit 120 may be set based on a frequency of the driving signal Sdrv, noise, and a transfer function of a path until the driving signal Sdrv is applied to the touch panel 200 and is output as the sensing signal Ssen. For example, the offset value may be an offset compensation level (for example, a compensation capacitance value of an offset compensation circuit or a coefficient of a digital filter circuit) for removing an offset capacitance of the touch panel 200. The frequency of the driving signal Sdrv may vary, and the offset value of the sensing circuit 120 may be again set. However a complicated analog circuit may be required for adjusting the voltage level of the periodic pulse signal PPS, thereby increasing an area of a driving circuit.

However, the touch controller 100 according to an exemplary embodiment of the inventive concept masks some pulses of the periodic pulse signal PPS to generate the driving signal, thereby adjusting the energy of the driving signal Sdrv without changing a frequency setting of the driving circuit 110. Therefore, in order to adjust the energy of the driving signal Sdrv, it is not required to change the offset value of the sensing circuit 120. Moreover, since a complicated analog circuit is not required, an area of the driving circuit 110 may be reduced.

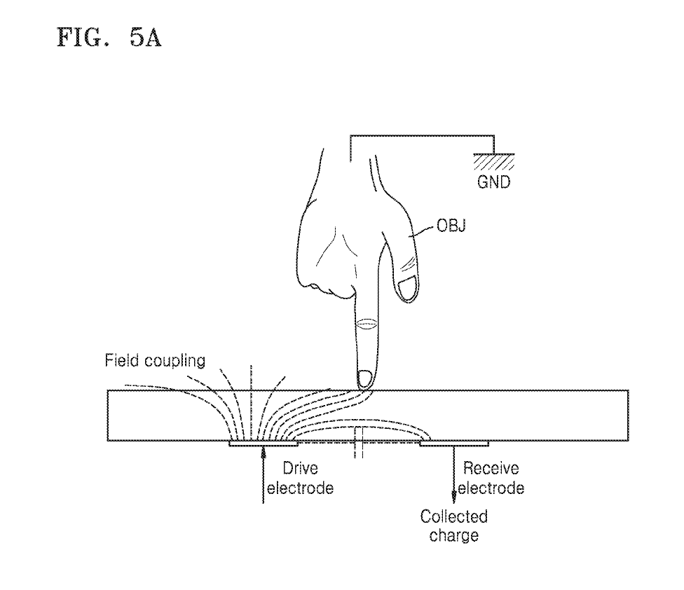

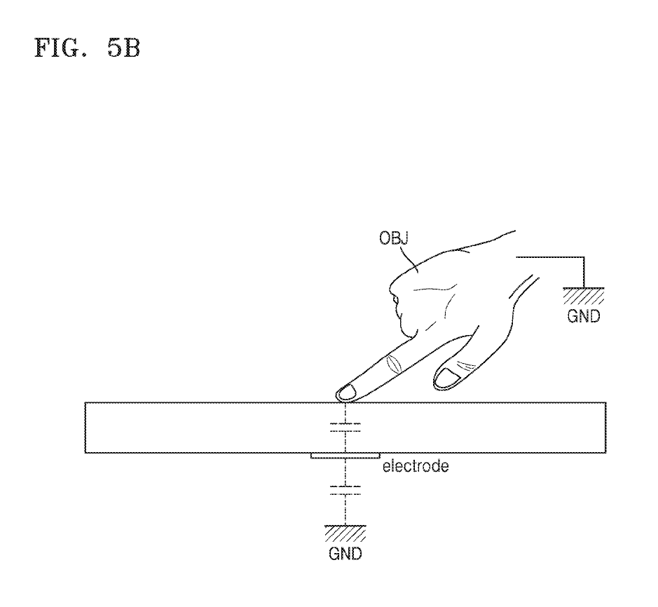

FIGS. 5A and 5B are diagrams for describing a capacitance variation of a sensing node based on a touch input. FIG. 5A is a diagram for describing a capacitance variation in a mutual capacitance sensing type. FIG. 5B is a diagram for describing a capacitance variation in a self-capacitance sensing type.

Referring to FIG. 5A, in the mutual capacitance sensing type, a voltage pulse is applied to a drive electrode, and a receive electrode (or referred to as a sensing electrode) collects an electrical charge corresponding to the voltage pulse. The voltage pulse supplied to the drive electrode may be the driving signal according to an embodiment described above with reference to FIGS. 1 and 3. In this case, when an object OBJ is located between the drive electrode and the receive electrode, an electric field illustrated as a dotted line may vary, and a variation of an intensity of the electric field causes a variation of a capacitance.

In this manner, a capacitance between electrodes may vary due to an electric field variation between the drive electrode and the receive electrode, and thus, a touch input may be sensed. FIG. 5A illustrates a contact touch, but a proximity touch may also cause a variation of an electric field. Also, FIG. 5A illustrates a case where the object OBJ is a finger, but a touch performed by another conductor such as a touch pen or the like may also cause a variation of an electric field.

Referring to FIGS. 5A and 2, in an embodiment, the row channels R1 to Rn of FIG. 1 may be driving channels, and the column channels C1 to Cm may be sensing channels. The driving channels may include a plurality of drive electrodes which are electrically connected to each other, and the sensing channels may include a plurality of sensing electrodes which are electrically connected to each other. In this case, the drive electrodes and the sensing electrodes may each be referred as a sensing unit. An intersection point between a drive electrode and a sensing electrode may be referred to as a sensing node. A capacitor may be formed between the drive electrode and the sensing electrode, and a capacitance of the capacitor may vary based on a touch input.

Referring to FIG. 5B, in the self-capacitance sensing type, a voltage pulse may be applied to an electrode, and the electrode may collect a voltage or an electrical charge corresponding to the voltage pulse. The voltage pulse supplied to the electrode (a drive electrode) may be the driving signal according to an embodiment described above with reference to FIGS. 1 and 3.

An electrode may cause a peripheral conductor (for example, a ground node or the like) and a capacitor to be formed. In this case, when the object OBJ contacts or approaches the electrode, a capacitance of a capacitor may increase. In this manner, a variation of the capacitor may be sensed through the electrode, and thus, a touch may be recognized.

Referring to FIGS. 5B and 2, in an embodiment, the row channels R1 to Rn and the column channels C1 to Cm may be driving channels as well as sensing channels. Electrodes (e.g., sensing units SU) included in the row channels R1 to Rn and the column channels C1 to Cm may each be referred to as a sensing node. The sensing node may cause a capacitor (for example, a floating capacitor) to be formed for a peripheral conductor, and a capacitance of a capacitor may vary based on a touch input.

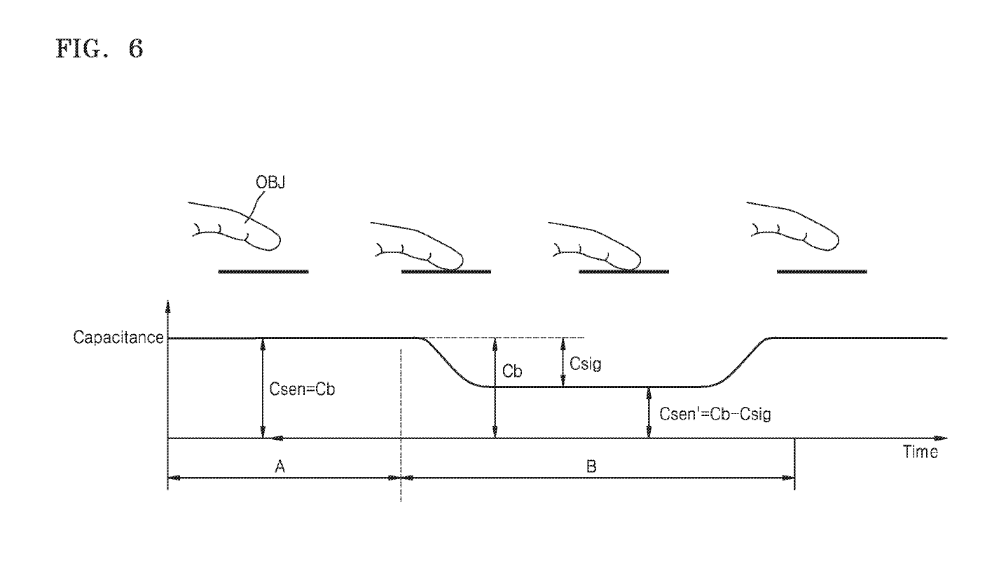

FIG. 6 is a graph for describing a capacitance variation rate of a sensing node based on a touch input.

Referring to FIG. 6, an X axis indicates a time, and a Y axis indicates a capacitance. Each of a plurality of sensing nodes may have a parasitic capacitance component Cb, and a capacitance value of each of the sensing nodes may vary due to a proximity or a contact made by an object OBJ. For example, as shown in FIG. 6, when the object OBJ approaches or contacts a sensing node, a capacitance value of the sensing node may be reduced. As another example, when the object OBJ approaches or contacts the sensing node, the capacitance value of the sensing node may increase. For example, in the mutual capacitance sensing type of FIG. 5A, the capacitance value of the sensing node may be reduced due to the proximity or the contact made by the object OBJ, and in the self-capacitance sensing type of FIG. 5B, the capacitance value of the sensing node may increase due to the proximity or the contact made by the object OBJ.

In FIG. 6, an A period indicates a state where the object OBJ does not contact the sensing node, and a capacitance value Csen of the sensing node has a Cb value corresponding to a parasitic capacitance value. Also, a B period of FIG. 6 indicates a case where the object OBJ contacts the sensing node. When the object OBJ (for example, a finger) approaches or contacts the sensing node, a capacitance component Csig based on the object OBJ is removed from the parasitic capacitance component Cb, and thus, a capacitance value Csen′ is reduced in comparison to Csen.

In an embodiment, when the object OBJ approaches or contacts the sensing node, the capacitance component Csig based on the object OBJ is added to the parasitic capacitance component Cb, and thus, the capacitance value Csen′ may increase.

In the touch sensing device 1000 according to the present embodiment described above with reference to FIG. 1, the driving circuit 110 of the touch controller 100 supplies the driving signal Sdrv to the electrodes (for example, the drive electrodes of the touch panel 200. The driving signal Sdrv is generated by skipping some pulses of the periodic pulse signal having the predetermined frequency. The sensing circuit 120 receives the sensing signal Ssen generated based on the driving signal Sdrv and based on the received sensing signal Ssen, determines whether a capacitance value of each of the sensing nodes increases or decreases and may detect a capacitance variation rate. Accordingly, the touch controller 100 may determine whether a touch input is applied to the touch panel 200 and may detect a position to which the touch input is applied.

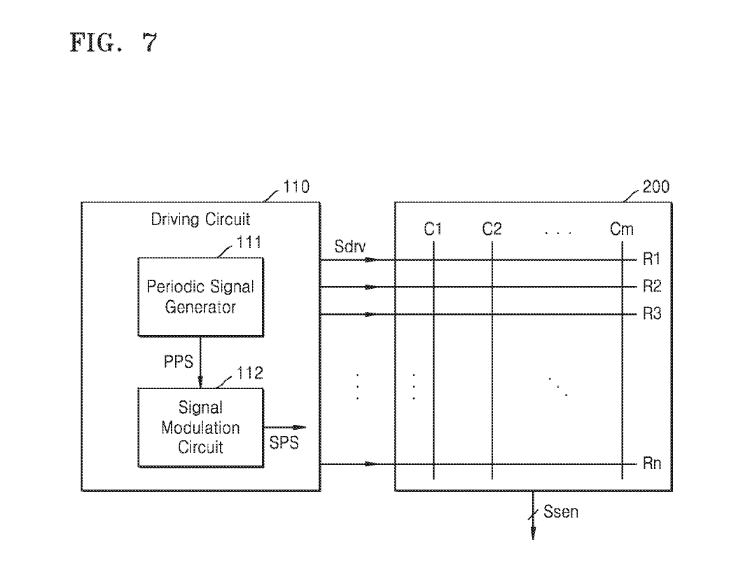

FIG. 7 is a diagram schematically illustrating a driving circuit 110 according to an exemplary embodiment of the inventive concept. For convenience of description, a touch panel 200 is also illustrated.

Referring to FIG. 7, the driving circuit 110 includes a periodic signal generator 111 and a signal modulation circuit 112.

The periodic signal generator 111 generates a periodic pulse signal PPS, based on a predetermined frequency. A frequency of the periodic pulse signal PPS may be referred to as a driving frequency or a carrier frequency.

The signal modulation circuit 112 generates a driving signal Sdrv, based on the periodic pulse signal PPS. The signal modulation circuit 112 masks some pulses of the periodic pulse signal PPS to generate a skip pulse signal SPS generated by skipping some pulses of the periodic pulse signal PPS. The signal modulation circuit 112 outputs the skip pulse signal SPS as the driving signal Sdrv.

The touch panel 200 may include a plurality of row channels R1 to Rn and a plurality of column channels C1 to Cm. In the following description, it is assumed that the row channels R1 to Rn are each a drive electrode receiving the driving signal Sdrv, and the column channels C1 to Cm are each a sensing electrode through which a sensing signal Ssen is output.

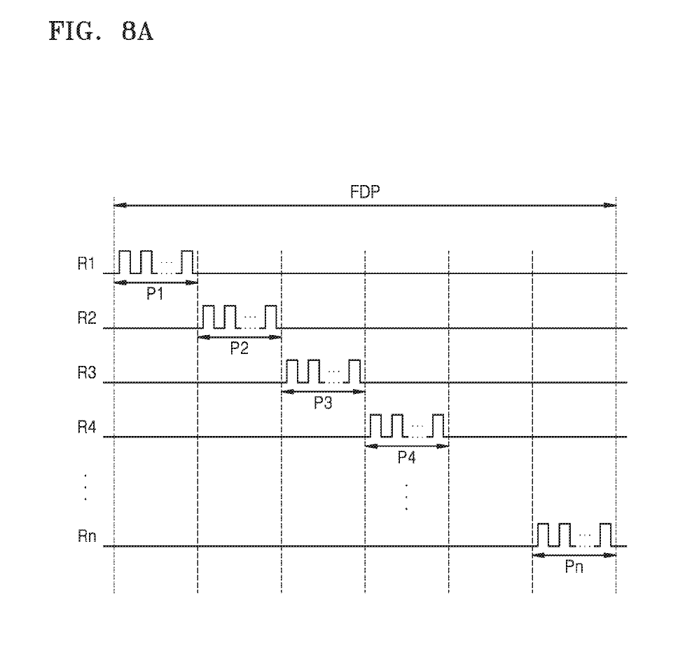

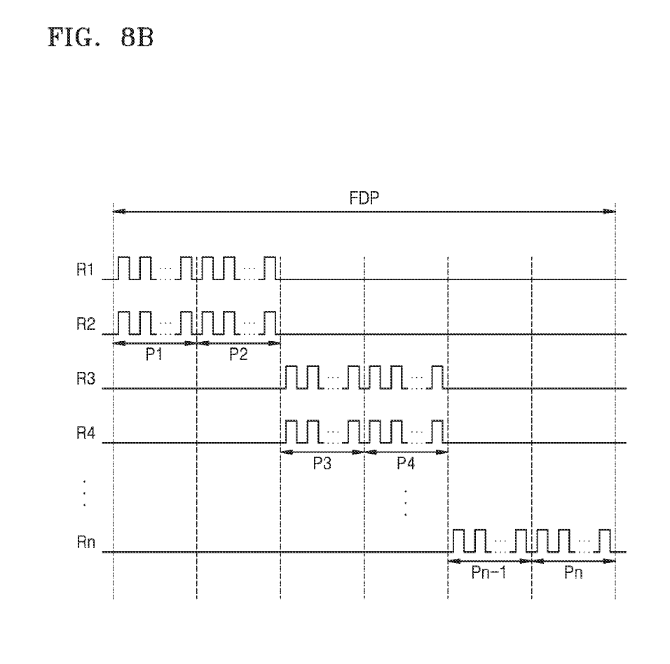

The driving circuit 110 supplies the driving signal Sdrv to the row channels R1 to Rn. The driving circuit 110 may supply the driving signal Sdrv by using various methods. This will be described in more detail with reference to FIGS. 8A and 8B.

FIGS. 8A and 8B are timing diagrams showing the driving signal Sdrv supplied to the row channels R1 to Rn based on a driving method of a driving circuit according to an embodiment.

As shown in FIGS. 8A and 8B, the driving signal Sdrv is supplied to all the row channels R1 to Rn in a frame driving period FDP. Referring to FIG. 8A, the driving signal Sdrv is supplied to one of the row channels R1 to Rn in each of a plurality of unit periods P1 to Pn. The driving circuit 110 may sequentially supply the driving signal Sdrv to the row channels R1 to Rn in the frame driving period FDP. The same driving signal Sdrv or different driving signals Sdrv may be supplied to the row channels R1 to Rn. In an embodiment, a driving signal Sdrv supplied to some row channels differ from a driving signal Sdrv supplied to other row channels. In the present embodiment, differing driving signals Sdrv denotes that a different number of pulses are included in the driving signals Sdrv or phases of the driving signals Sdrv differ.

Referring to FIG. 8B, the driving signal Sdrv is simultaneously supplied to a plurality of row channels in a plurality of unit periods. For example, as shown in FIG. 8B, the driving signal Sdrv is supplied to first and second row channels R1 and R2 in first and second unit periods P1 and P2, and then, the driving signal Sdrv is supplied to third and fourth row channels R3 and R4 in third and fourth unit periods P3 and P4. In this way, the driving signal Sdrv may be simultaneously supplied to two row channels at every two unit periods. However, the present embodiment is not limited thereto. In other embodiments, the driving signal Sdrv may be simultaneously supplied to three or more row channels.

The driving circuit 110 may simultaneously supply the driving signal Sdrv to some of a plurality of channels. Such a driving method may be referred to as a multi-driving method. For example, the driving circuit 110 may simultaneously supply the driving signal Sdrv in units of a predetermined plurality of channels. In this case, different driving signals Sdrv may be respectively supplied to the plurality of channels.

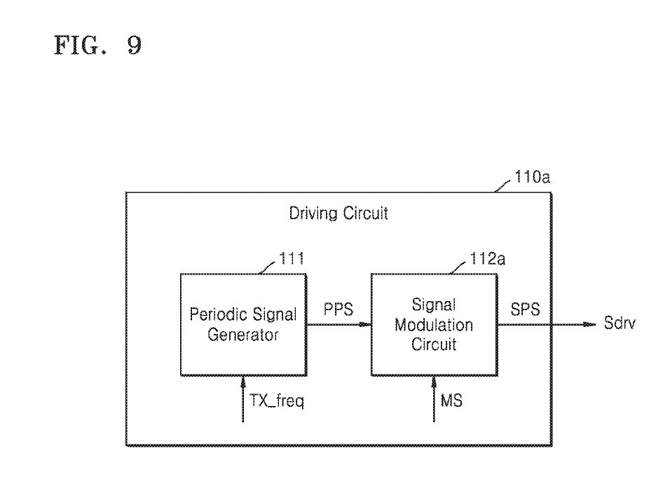

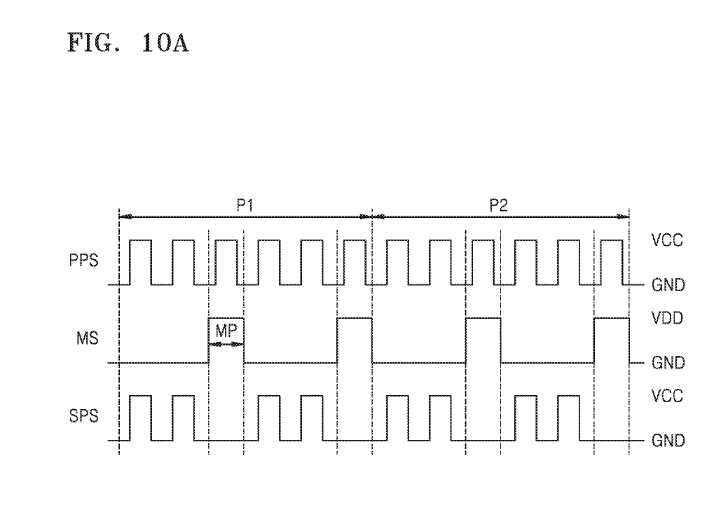

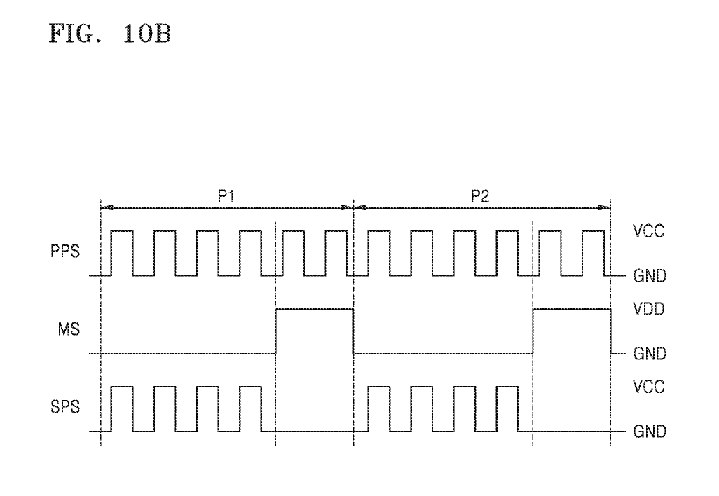

FIG. 9 is a block diagram illustrating a driving circuit 110a according to an exemplary embodiment of the inventive concept. FIGS. 10A and 10B are timing diagrams of the driving circuit 110a of FIG. 9. The driving circuit 110 of FIG. 1 may be replaced with the driving circuit 110a of FIG. 9.

Referring to FIG. 9, the driving circuit 110a includes a periodic signal generator 111 and a signal modulation signal 112a.

The periodic signal generator 111 generates a periodic pulse signal PPS, based on frequency information TX_freq supplied from control logic (130 of FIG. 1). In an embodiment, the periodic signal generator 111 switch between application of two source voltages to generate the periodic pulse signal PPS, based on a frequency which is set based on the frequency information TX_freq. For example, one of the two source voltages may be a source voltage VCC applied from a source located outside a touch controller (100 of FIG. 1), and the other may be a ground voltage GND. However, the present embodiment is not limited thereto. In an embodiment, the periodic signal generator 111 may be implemented with various circuits that generate the periodic pulse signal PPS, based on the frequency information TX_freq.

The signal modulation circuit 112a generates a skip pulse signal SPS, based on the periodic pulse signal PPS and masking information which is received from the control logic 130. The masking information, as shown in FIGS. 10A and 10B, may include a masking signal MS, indicating a masking period, or the number of masked pulses. In an embodiment, the masking signal MS is a logic signal.

As shown in FIGS. 10A and 10B, the signal modulation circuit 112a generates the skip pulse signal SPS by masking a pulse, applied in the masking period MP, among pulses of the periodic pulse signal PPS, based on the masking signal MS. In an embodiment, the signal modulation circuit 112a is implemented with a flip flop or a latch. The periodic pulse signal PPS is applied to the signal modulation circuit 112a and the skip pulse signal SPS is output in response to the masking signal MS. However, the present embodiment is not limited thereto. In other embodiments, the signal modulation circuit 112a may be implemented with various circuits. In an embodiment, the masking signal MS is ground voltage GND or a higher supply voltage VDD.

Referring to FIGS. 10A and 10B, a voltage level of the skip pulse signal SPS is the same as that of the periodic pulse signal PPS, and the skip pulse signal SPS has a waveform generated by skipping some pulses of the periodic pulse signal PPS.

As shown in FIG. 10A, a plurality of pulses of the periodic pulse signal PPS may be non-continuously masked, and as shown in FIG. 10B, the plurality of pulses of the periodic pulse signal PPS may be continuously masked.

In FIGS. 10A and 10B, it is illustrated that the plurality of pulses of the periodic pulse signal PPS are masked at each of the unit periods P1 and P2, but the present embodiment is not limited thereto. In other embodiments, one pulse may be masked at every one unit period, and moreover, a different number of pulses may be masked at each of the unit periods P1 and P2. For example, in FIG. 10A, every third pulse is masked out during each period (e.g., P1 or P2), and in FIG. 10B, the last two pulses is masked out during each period.

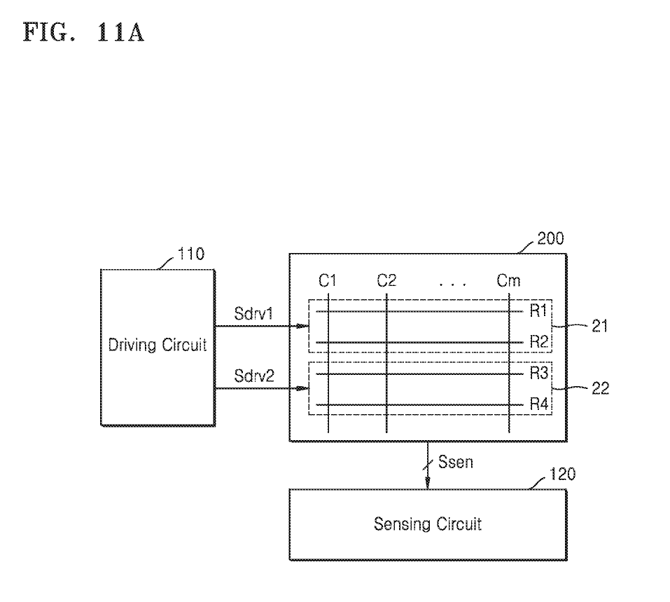

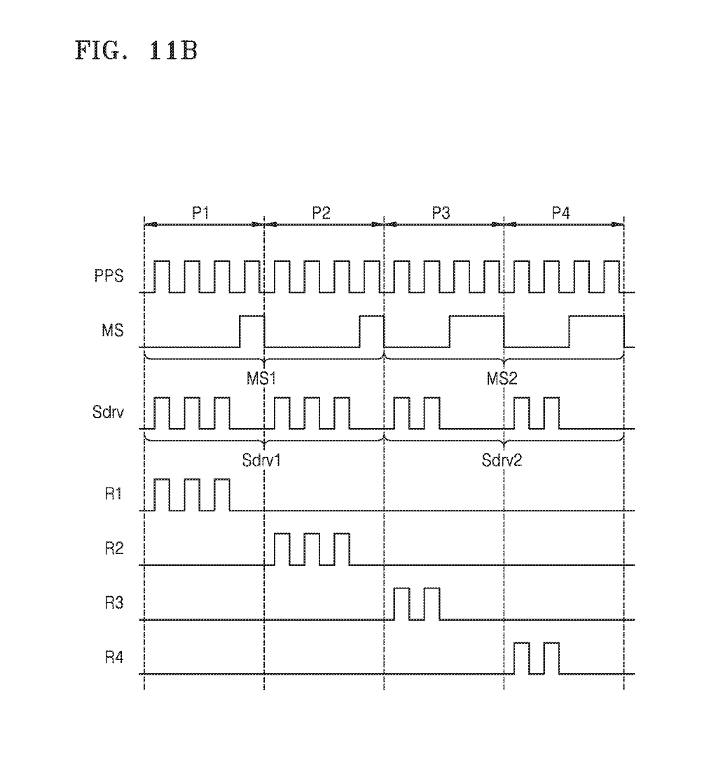

FIG. 11A is a diagram illustrating a driving method of a driving circuit according to an exemplary embodiment of the inventive concept, and FIG. 11B is a timing diagram of a touch panel and a touch circuit based on the driving method of the driving circuit of FIG. 11A. The driving circuit 110a described above with reference to FIG. 9 may be applied as a driving circuit 110 according to the present embodiment.

Referring to FIG. 11A, a touch panel 200 may include a plurality of row channels R1 to Rn and a plurality of column channels C1 to Cm. For convenience of description, the touch panel 200 is assumed to include four row channels R1 to R4.

The driving circuit 110 may supply different driving signals Sdrv1 and Sdrv2 to the row channels R1 to R4. The driving circuit 110 supplies a first driving signal Sdrv1 to one or more row channels (e.g., R1 and R2) and may supplies a second driving signal Sdrv2 to other one or more row channels (e.g., R3 and R4). The first driving signal Sdrv1 and the second driving signal Sdrv2 may differ from one another.

In an embodiment, as shown in FIG. 11A, the first driving signal Sdrv1 is supplied to a first channel group 21, and the second driving signal Sdrv2 is supplied to a second channel group 22.

Referring to FIG. 11B, the driving circuit 110 generates the first driving signal Sdrv1, based on a first masking signal MS1 which is received in first and second unit periods P1 and P2 and generates the second driving signal Sdrv2, based on a second masking signal MS2 which is received in third and fourth unit periods P3 and P4. For example, the first masking signal MS1 may be used to mask out one fourth of the pulses and the second masking signal MS2 may be used to mask out half of the pulses. The driving circuit 110 may supply the first driving signal Sdrv1 to the row channels R1 and R2 of the first channel group 21 in the first and second unit periods P1 and P2 and may supply the second driving signal Sdrv2 to the row channels R3 and R4 of the second channel group 22 in the third and fourth unit periods P3 and P4.

In an embodiment, a distance between the first channel group 21 and the sensing circuit 120 is relatively longer than a distance between the second channel group 22 and the sensing circuit 120, and the number of pulses of the first driving signal Sdrv1 is larger than the number of pulses of the second driving signal Sdrv2. Therefore, in this embodiment, the driving circuit 110 supplies a driving signal having higher energy to a driving channel which is disposed relatively farther away from the sensing circuit 120, thereby reducing a difference in sensing signal based on a position of the driving channel.

However, the present embodiment is not limited thereto, and a driving signal supplied to the row channels R1 to R4 may be variously modified within a technical scope where different driving signals Sdrv1 and Sdrv2 are supplied to the row channels R1 to R4.

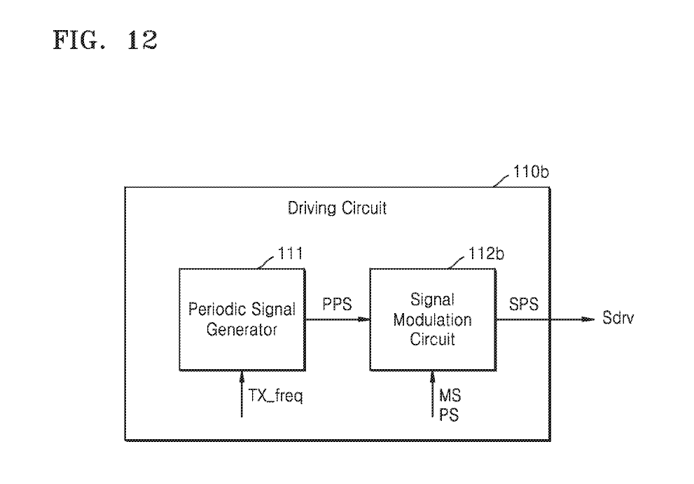

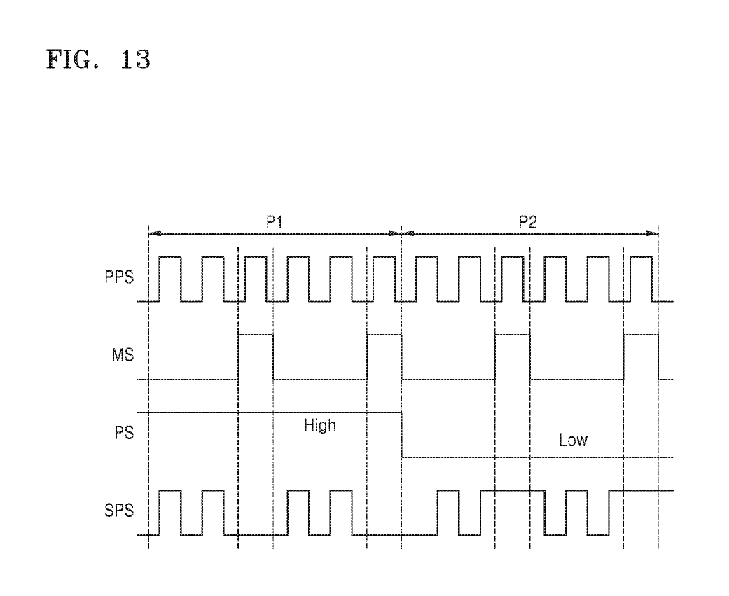

FIG. 12 is a block diagram illustrating an implementation example of a driving circuit 110b according to an exemplary embodiment of the inventive concept. FIG. 13 is a timing diagram of the driving circuit 110b of FIG. 12. The driving circuit 110 of FIG. 1 may be replaced with the driving circuit 110b of FIG. 12.

Referring to FIG. 12, the driving circuit 110b includes a periodic signal generator 111 and a signal modulation circuit 112b.

The periodic signal generator 111 is the same as the periodic signal generator 111 of the driving circuit 110a of FIG. 9, and thus, a repetitive description is not repeated.

The signal modulation circuit 112b generates a skip pulse signal SPS, based on phase information and masking information received from the control logic 130 and a periodic pulse signal PPS and outputs the skip pulse signal SPS as a driving signal Sdrv.

The masking information, as shown in FIG. 13, may include a masking signal MS, indicating a masking period, or the number of masked pulses.

The phase information may include a phase signal PS indicating the same phase or an opposite phase. As shown in FIG. 13, the phase signal PS may have a first level (for example, a logic high level) or a second level (for example, a logic low level). For example, the first level may indicate the same phase as that of the periodic pulse signal PPS, and the second level may indicate a phase opposite to that of the periodic pulse signal PPS.

Referring to FIG. 13, the signal modulation circuit 112b masks some pulses of the periodic pulse signal PPS, based on the masking signal MS and the phase signal PS and may shift a phase, thereby generating the skip pulse signal SPS. For example, during the first unit period P1, every third pulse is masked out from the periodic pulse signal PPS and no phase change is applied to generate the skip pulse signal SPS. For example, during the second unit period P2, every third pulse is masked out from the periodic pulse signal PPS to generate a resulting signal and the resulting signal is inverted to generate the skip pulse signal.

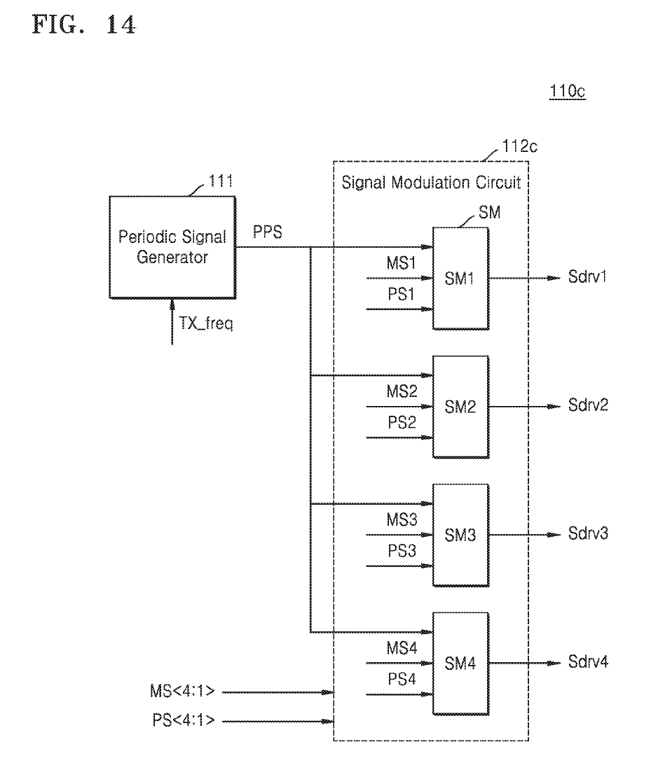

FIG. 14 is a block diagram illustrating a driving circuit 110c according to an exemplary embodiment of the inventive concept. The driving circuit 110 of FIG. 1 may be replaced with the driving circuit 110c of FIG. 14.

Referring to FIG. 14, the driving circuit 110c includes a periodic signal generator 111 and a signal modulation circuit 112c. The signal modulation circuit 112c includes a plurality of signal modulators SM1 to SM4.

The plurality of signal modulators SM1 to SM4 receive a periodic pulse signal PPS output from the periodic signal generator 111 and respectively generate a plurality of skip pulse signals, based on a plurality of masking signals MS1 to MS4 and a plurality of phase signals PS1 to PS4 respectively applied to the signal modulators SM1 to SM4. The skip pulse signals may be simultaneously output as driving signals Sdrv1 to Sdrv4. In an embodiment, in FIG. 14, the signal modulation circuit 112b is illustrated as including four signal modulators SM1 to SM4, but is not limited thereto. The number of the signal modulators may vary. For example, the number of the signal modulators may vary according to the number of drive electrodes to which a driving signal is simultaneously applied.

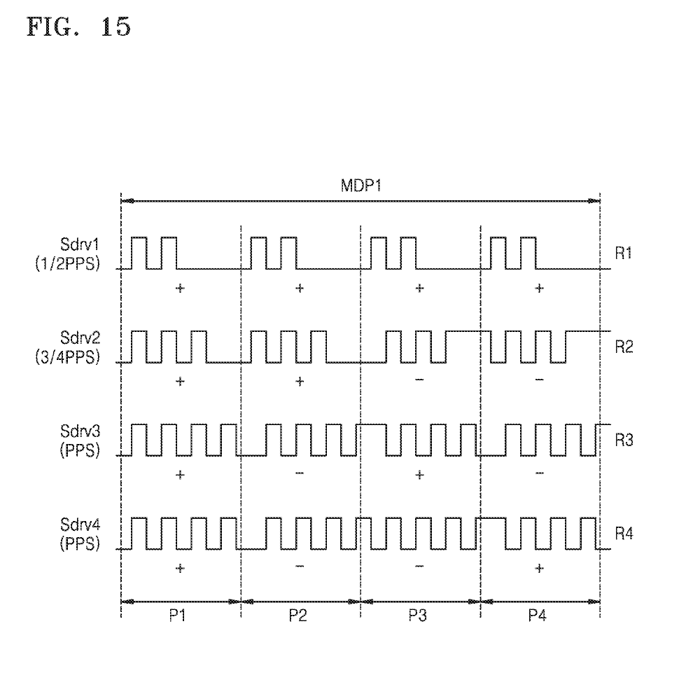

FIG. 15 is a diagram for describing a multi-driving method of a touch controller according to an exemplary embodiment of the inventive concept.

A multi-driving method performed in units of four driving channels based on first to fourth driving signals Sdrv1 to Sdrv4 will be described with reference to FIG. 15 for example. The first to fourth driving signals Sdrv1 to Sdrv4 may be generated by the above-described driving circuit 110c of FIG. 14. The first to fourth driving signals Sdrv1 to Sdrv4 may be respectively applied to first to fourth row channels R1 to R4 in a first multi-driving period MDP1 including first to fourth unit periods P1 to P4. Subsequently, the first to fourth driving signals Sdrv1 to Sdrv4 may be respectively applied to four other row channels in a second multi-driving period. In this manner, multi-driving may be performed in units of four driving channels.

At least some of the first to fourth driving signals Sdrv1 to Sdrv4 may be skip pulse signals described above with reference to FIGS. 1 to 13. For example, the first driving signal Sdrv1 may be a skip pulse signal generated by skipping half of pulses of a periodic pulse signal PPS. The third and fourth driving signals Sdrv3 and Sdrv4 may be signals which are obtained without skipping the pulses of the period pulse signal PPS. In this case, a ratio (e.g., ½, ¾, 1, or 1) of the number of pulses of each of the first to fourth driving signals Sdrv1 to Sdrv4 to the number of the pulses of the period pulse signal PPS may be referred to as a control coefficient of each of the first to fourth driving signals Sdrv1 to Sdrv4.

A phase of each of the first to fourth driving signals Sdrv1 to Sdrv4 may be shifted in each of the first to fourth unit periods P1 to P4 as shown. In FIG. 15, + indicates a positive phase, and − indicates a negative phase. A phase difference between + and − may be a 180-degree phase difference.

Sensing signals based on the first to fourth driving signals Sdrv1 to Sdrv4 which are applied in each of the first to fourth unit periods P1 to P4 may be received through sensing electrodes, for example, column channels (C1 to Cm of FIG. 2). In this case, since the first to fourth driving signals Sdrv1 to Sdrv4 are simultaneously applied to the plurality of row channels R1 to R4, the sensing signals output through the respective sensing channels may be values obtained by adding sensing values based on the first to fourth driving signals Sdrv1 to Sdrv4. Touch data based on each of the first to fourth unit periods P1 to P4 may be expressed by the following Equation (1):

T1=1/2CR1+3/4CR2+CR3+CR4

T2=1/2CR1+3/4CR2−CR3−CR4

T3=1/2CR1−3/4CR2+CR3−CR4

T4=1/2CR1−3/4CR2−CR3+CR4 (1)

where T1 to T4 denote first to fourth touch data, respectively. The first to fourth touch data T1 to T4 each indicate touch data based on a sensing signal which is sensed in each of the first to fourth unit periods P1 to P4. CR1 to CR4 denote sensing values (e.g., capacitances) of sensing nodes connected to the first to fourth row channels R1 to R4, respectively. For example, when a sensing signal is received through a first column channel C1, CR1 to CR4 may denote capacitances of sensing nodes disposed at intersection points between the first to fourth row channels R1 to R4 and the first column channel C1. The control coefficients (e.g., ½, ¾, 1) of Equation (1) may denote weights that are applied to the detected capacitances along a column of the touch panel 200 based on the amount of masking performed to the driving signal Sdrv applied to each sensing node of the column.

When the touch data based on Equation (1) is decoded based on a decoding code, a decoding result value may be calculated as expressed in the following Equation (2). For example, the decoding code may be set based on a phase signal PS which is provided when the driving circuit 110 generates the first to fourth driving signals Sdrv1 to Sdrv4:

T1+T2+T3+T4=2CR1

T1+T2−T3−T4=3CR2

T1−T2+T3−T4=4CR3

T1−T2−T3+T4=4CR4 (2)

where 2CR1, 3CR2, 4CR3, and 4CR4 denote decoding result values, respectively.

When the decoding result values 2CR1, 3CR2, 4CR3, and 4CR4 are compensated for based on the reciprocals (for example, 2, 4/3, and 1) of the control coefficients of the first to fourth driving signals Sdrv1 to Sdrv4 respectively corresponding to the decoding result values, compensation result output values may be output as 4CR1, 4CR2, 4CR3, and 4CR4. Sensing values CR1 to CR4 (e.g., capacitance values) of respective sensing nodes may be calculated based on the compensation result output values 4CR1, 4CR2, 4CR3 and 4CR4.

In an embodiment, a sensing circuit (120 of FIG. 1) generates the first to fourth touch data T1 to T4, based on sensing signals Ssen output through respective sensing channels (e.g., the column channels C1 to Cm) and supplies the generated first to fourth touch data T1 to T4 to the control logic 130. The control logic 130 may perform decoding and compensation to calculate a sensing value of each sensing node.

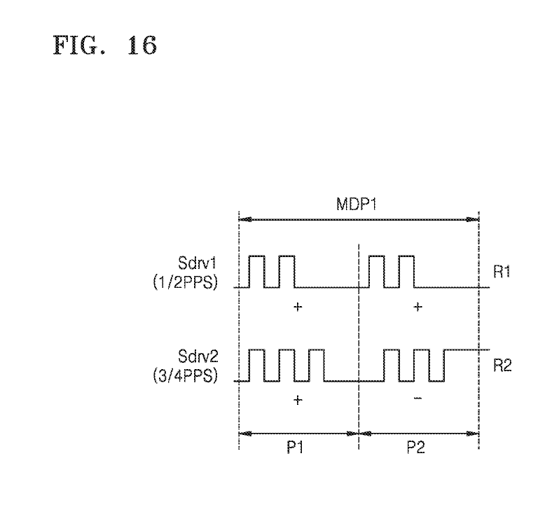

FIG. 16 is a diagram for describing a multi-driving method of a touch controller according to an exemplary embodiment of the inventive concept.

A multi-driving method performed in units of two driving channels based on first and second driving signals Sdrv1 and Sdrv2 will be described with reference to FIG. 16 for example.

The first and second driving signals Sdrv1 and Sdrv2 may be respectively applied to first and second row channels R1 and R2 in a first multi-driving period MDP1 including first and second unit periods P1 and P2. Subsequently, the first and second driving signals Sdrv1 and Sdrv2 may be respectively applied to two other row channels in a second multi-driving period. In this manner, multi-driving may be performed in units of two driving channels.

At least one of the first and second driving signals Sdrv1 and Sdrv2 may be a skip pulse signal described above with reference to FIGS. 1 to 13. For example, the first driving signal Sdrv1 may be a skip pulse signal generated by skipping half of pulses of a periodic pulse signal PPS, and the second driving signal Sdrv2 may be a skip pulse signal generated by skipping one-fourth of the pulses of the periodic pulse signal PPS. A phase of each of the first and second driving signals Sdrv1 and Sdrv2 may be shifted in each of the first and second unit periods P1 and P2 as shown.

Sensing signals based on the first and second driving signals Sdrv1 and Sdrv2 which are applied in each of the first and second unit periods P1 and P2 may be received through sensing electrodes, for example, column channels (C1 to Cm of FIG. 2). In this case, since the first and second driving signals Sdrv1 and Sdrv2 are simultaneously applied to the first and second row channels R1 and R2, the sensing signals output through the respective sensing channels may be values obtained by adding sensing values based on the first and second driving signals Sdrv1 and Sdrv2. Touch data based on each of the first and second unit periods P1 and P2 may be expressed by the following Equation (3):

T1=1/2CR1+3/4CR2

T2=1/2CR1−3/4CR2 (3)

where T1 and T2 denote first and second touch data, respectively. The first and second touch data T1 and T2 each indicate touch data based on a sensing signal which is sensed in each of the first and second unit periods P1 and P2. CR1 and CR2 denote sensing values (e.g., capacitances) of sensing nodes connected to the first and second row channels R1 and R2, respectively.

As described above, the touch data based on Equation (3) may be decoded based on a decoding code, and when a result of the decoding is compensated for based on the reciprocals of control coefficients of the first and second driving signals Sdrv1 and Sdrv2, sensing values CR1 and CR2 of respective sensing nodes may be calculated.

As described above with reference to FIGS. 15 and 16, the touch controller 100 according to an embodiment of the present inventive concept may sense a touch input of the touch panel 100 in a multi-driving method, based on driving signals having a different number of pulses per unit period.

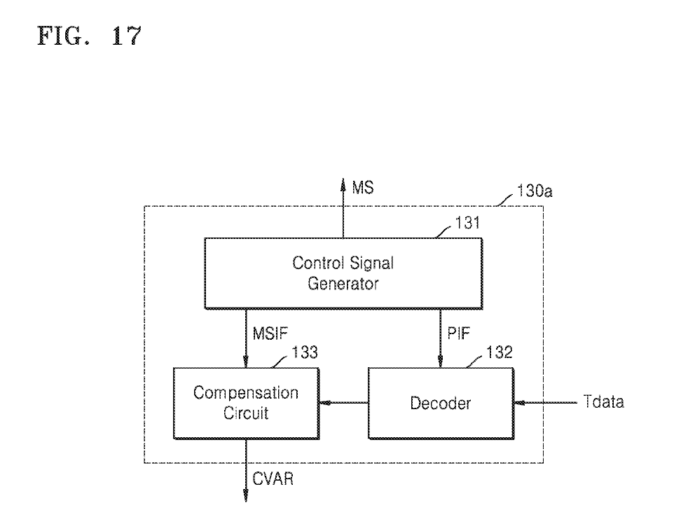

FIG. 17 is a block diagram illustrating an implementation example of control logic 130a according to an exemplary embodiment of the inventive concept. The control logic 130 of FIG. 1 may be replaced with the control logic 130a of FIG. 17.

Referring to FIG. 17, the control logic 130a includes a control signal generator 131, a decoder 132 (e.g., a decoding circuit), and a compensation circuit 133. The control logic 130a may further include a circuit (for example, a digital filter circuit) for removing noise included in touch data Tdata. The control signal generator 131 may generate first and second control signals CON1 and CON2 and may respectively output the first and second control signals CON1 and CON2 to a driving circuit (110 of FIG. 1) and a sensing circuit (120 of FIG. 1). The first control signal CON1 may be a signal for controlling an operation of the driving circuit 110 and may include frequency information, masking information MSIF, phase information PIF, etc. The second control signal CON2 may be a signal for controlling an operation of the sensing circuit 120 and may include, for example, a timing signal indicating a sensing time.

The control signal generator 131 may adjust the masking information MSIF and the phase information PIF, based on a predetermined value or an analysis result obtained by analyzing the touch data Tdata. The control signal generator 131 may supply the phase information PIF to the decoder 132 and may supply the masking information MSIF to the compensation circuit 133.

The decoder 132 may decode the touch data Tdata, based on a decoding code which is set based on the phase information PIF.

In an embodiment, the compensation circuit 133 calculates control coefficients of a plurality of driving signals, based on the masking information MSIF and compensates for data output from the decoder 132, based on the control coefficients. Therefore, a sensing value (for example, a capacitance value and a capacitance variation rate CVAR) of each of a plurality of sensing nodes may be calculated.

In FIG. 17, the control signal generator 131, the decoder 132 (e.g., decoding circuit), and the compensation circuit 133 are illustrated as separate blocks. However, this is for convenience of description, and the present embodiment is not limited thereto. The control signal generator 131, the decoder 132, and the compensation circuit 133 may be implemented as one or more software modules or hardware modules.

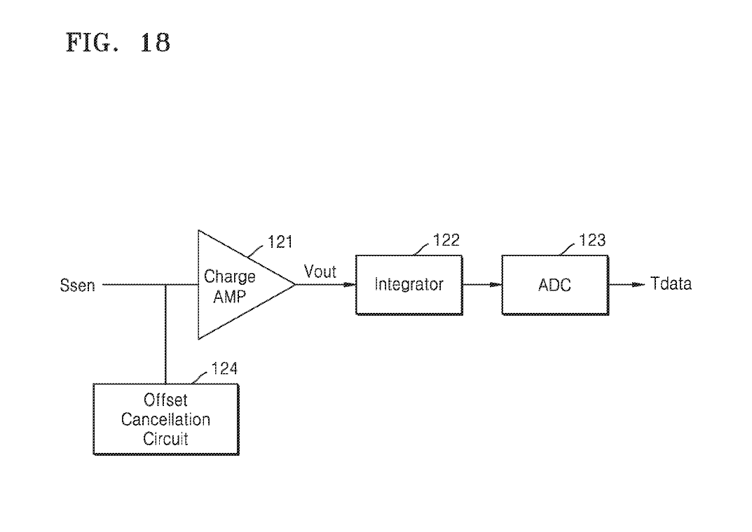

FIG. 18 is a block diagram schematically illustrating a sensing circuit 120 according to an exemplary embodiment of the inventive concept.

Referring to FIG. 18, the sensing circuit 120 includes a charge amplifier 121, an integrator 122 (e.g., a circuit configured to perform an electronic integration), and an ADC 123 (e.g., a circuit configured to perform an analog to digital conversion). Also, the sensing circuit 120 may further include an offset cancellation circuit.

The charge amplifier 121 may generate a sensing voltage from a sensing signal Ssen. In an embodiment, the charge amplifier 121 converts the sensing signal Ssen, which is a current signal output from the touch panel 200, into a sensing voltage Vout that is a voltage signal. Therefore, the charge amplifier 121 may be referred to as a Q-V converter or a capacitance-voltage converter.

The integrator 122 may integrate (or accumulate) the sensing voltage Vout output from the charge amplifier 121. For example, the integrator 122 may perform an integration operation at least two or more times. In an embodiment, the ADC 123 performs an analog-digital conversion operation on an output of the integrator 122 to generate touch data Tdata. The offset cancellation circuit 124 may cancel an offset capacitance from the sensing signal Ssen. In an embodiment, the offset cancellation circuit 124 may include an offset cancellation circuit.

The touch data Tdata generated by the sensing circuit 120 may be supplied to a control logic (130 of FIG. 1), and the control logic 130 may data-process the touch data Tdata to calculate a capacitance variation rate CVAR of a sensing node.

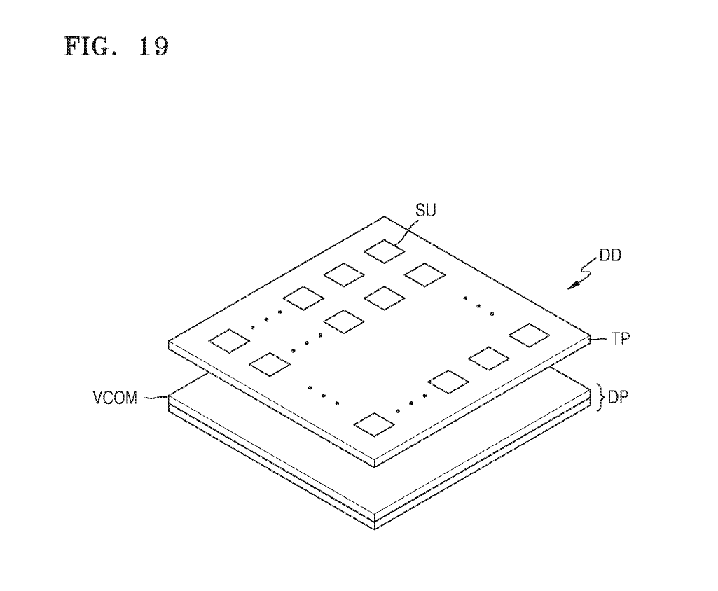

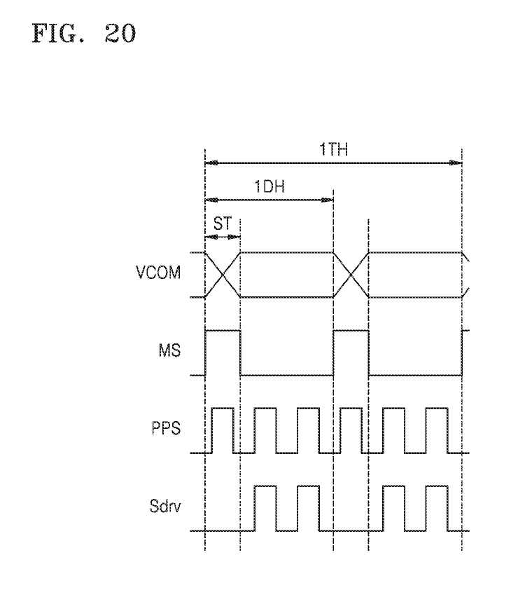

FIG. 19 is a diagram illustrating a touch panel and a display panel included in a touch sensing device TSD according to an exemplary embodiment of the inventive concept. FIG. 20 is a timing diagram of a driving circuit according to an exemplary embodiment of the inventive concept.

Referring to FIG. 19, the touch sensing device TSD includes a touch panel TP and a display panel DP. The touch sensing device 1000 of FIG. 1 according to an exemplary embodiment may be implemented like the touch sensing device TSD illustrated in FIG. 19.

The display panel DP may be implemented with a liquid crystal display (LCD), a light emitting diode (LED) display, an organic light emitting diode (OLED) display, an active-matrix OLED display, or a flexible display, or may be implemented with other kinds of flat panel displays.

The touch panel TP may be integrated with the display panel DP. FIG. 19 illustrates an example where the touch panel TP is disposed over the display panel DP, but the present embodiment is not limited thereto. In other embodiments, the touch panel TP may be disposed under the display panel DP. The touch panel TP may be spaced apart from the display panel DP by a certain distance, or may be attached on an upper substrate of the display panel DP.

FIG. 19 illustrates an on-cell type where the display panel DP is provided as a separate panel or layer different from the touch panel TP, but the present embodiment is not limited thereto. In some embodiments, the touch sensing device TSD may be implemented as an in-cell type where a display panel used to display an image and a sensing unit SU used to sense a touch are disposed on the same layer.

Since the touch panel TP is disposed adjacent to the display panel DP, a driving signal applied to the touch panel TP may degrade the image quality of the display panel DP. Further, the driving signal applied to the display panel DP, polarity conversion of a common voltage VCOM applied to a common electrode of the display panel DP or data signals applied to the display panel DP, may cause noise in the touch panel 200, causing the degradation in touch sensing characteristic.

However, by using a driving method according to at least one embodiment of the present embodiment, a driving signal Sdrv is generated by masking some pulses of a periodic pulse signal PPS. In this case, by adjusting a pulse masking period, noises caused by the driving signal Sdrv may be reduced.

As shown in FIG. 20, a touch controller (100 of FIG. 1) may set, as a masking period of a masking signal MS, a polarity conversion period ST of the common voltage VCOM or a period where the data signals are applied to the display panel DP. For example, the masking period may occur during the polarity conversion period ST where a polarity of the common voltage VCOM changes. The period 1DH illustrated in FIG. 20 includes the polarity conversion period ST in which the polarity of the common voltage VCOM changes from a first polarity to a second polarity and a period of time during which the common voltage VCOM maintains the second polarity. The period 1TH illustrated in FIG. 20 may correspond to a frame driving period FDP.

Therefore, in an operation where the driving signal Sdrv is generated by masking some pulses of periodic pulse signal PPS, a pulse is not applied to the touch panel TP in the polarity conversion period ST of the common voltage VCOM or the period where the data signals are applied to the display panel DP. Noises caused by driving signals respectively applied to the touch panel TP and the display panel DP are minimized, thereby preventing the degradation in touch sensing characteristic and the image quality characteristic of the display panel DP.

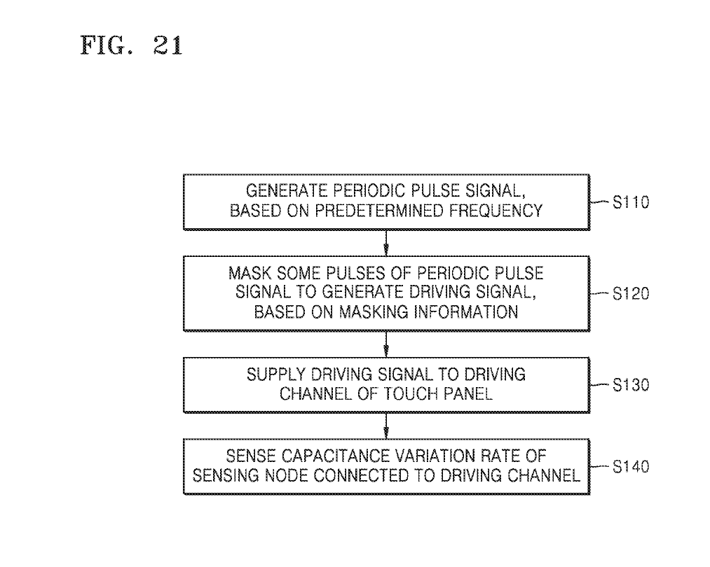

FIG. 21 is a flowchart illustrating a touch sensing method according to an exemplary embodiment of the inventive concept. The touch sensing method of FIG. 21 may be performed by the touch sensing device 1000 of FIG. 1, and in detail, the touch controller 100.

Referring to FIG. 21, in operation S110, the driving signal 110 generates a periodic pulse signal, based on a predetermined frequency. In operation S120, the driving circuit 110 generates a skip pulse signal (or a masked periodic pulse signal), obtained by masking some pulses of the periodic pulse signal, as a driving signal based on masking information.

In operation S130, the driving circuit 110 supplies the driving signal to a driving channel of the touch panel 200. The driving channel may be one of a plurality of row channels or a plurality of column channels.

In operation S140, the sensing circuit 120 and the control logic 130 senses a capacitance of a sensing node connected to a driving channel. The sensing circuit 120 may receive the sensing signal and may convert the sensing signal into touch data. The control logic 130 may calculate a capacitance value and a capacitance variation rate of the sensing node, based on the touch data.

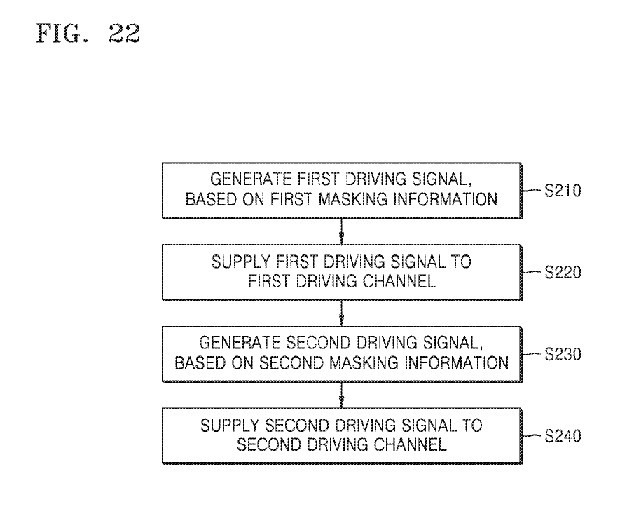

FIG. 22 is a flowchart illustrating in detail an operation of generating a driving signal and an operation of supplying the driving signal to a driving channel illustrated in FIG. 21, according to an exemplary embodiment of the inventive concept. The method of FIG. 22 may be performed by the driving circuit 110 of FIG. 1.

Referring to FIG. 22, the driving circuit 110 generates a first driving signal, based on first masking information in operation S210 and supplies the first driving signal to a first driving channel in operation S220. Subsequently, the driving circuit 110 generates a second driving signal, based on second masking information in operation S230 and supplies the second driving signal to a second driving channel in operation S240. The first driving signal and the second driving signal may be signals generated based on a periodic pulse signal. However, the number of pulses of the first driving signal per unit period may differ from the number of pulses of the second driving signal per unit period. Accordingly, different driving signals may be sequentially supplied to a plurality of driving channels.

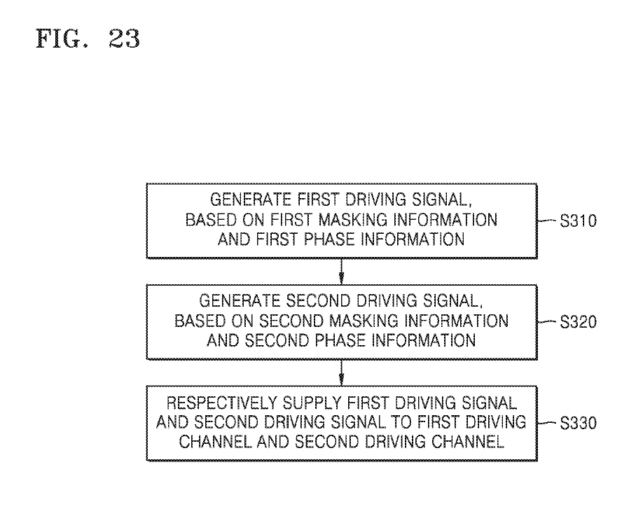

FIG. 23 is a flowchart illustrating in detail an operation of generating a driving signal and an operation of supplying the driving signal to a driving channel illustrated in FIG. 21, according to an exemplary embodiment of the inventive concept. The method of FIG. 23 may be the multi-driving method described above with reference to FIGS. 15 and 16 and may be performed by the driving circuit 110c of FIG. 14.

Referring to FIG. 23, the driving circuit 110c generates a first driving signal, based on first masking information and first phase information in operation S310 and generates a second driving signal, based on second masking information and second phase information in operation S320. Operations S310 and S320 may be simultaneously performed.

In operation S330, the driving circuit 110c supplies the first driving signal and the second driving signal to a first driving channel and a second driving channel, respectively. The supply of the first and second driving signals may occur simultaneously.

Subsequently, the driving circuit 110c may repeat operations S310 and S320, and thus, a touch panel (120 of FIG. 1) may be multi-driven by simultaneously supplying the first driving signal and the second driving signal to two driving channels.

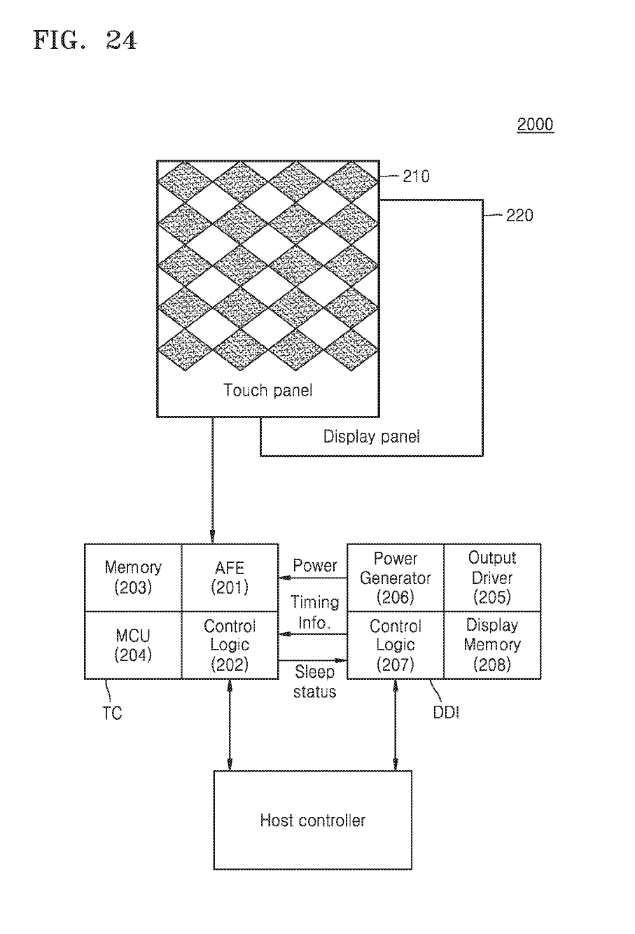

FIG. 24 is a block diagram illustrating a touch screen device 2000 including a touch controller according to an exemplary embodiment of the inventive concept.

Referring to FIG. 24, the touch screen device 2000 includes a touch panel 210, a display panel 220, a touch controller TC controlling the touch panel 210, and a display driving circuit DDI controlling the display panel 220.

The touch controller TC includes an analog front end (AFE) 201, touch control logic 202, a memory 203, and a micro controller unit (MCU) 204. The AFE 201 may include the driving circuit 110 and the sensing circuit 120 illustrated in FIG. 1. The AFE 201 may sense a touch input applied to a touch panel TP to generate touch data. The AFE 201 may include sensitive analog amplifiers, operational amplifiers, filters, application-specific integrated circuits, radio receivers, etc. The memory 203 may store the touch data. The touch control logic 202 and the MCU 204 may correspond to the control logic 130 of FIG. 1. The touch control logic 202 may control an operation of the AFE 201 and an overall operation of the touch controller TC. The MCU 204 may calculate touch coordinates, based on the touch data output from the AFE 201 or the touch data stored in the memory 203.

The display driving circuit DDI includes an output driver 205, a power generator 206, a display memory 208, and display control logic 207. The output driver 205 may include a source driver, which respectively supplies grayscale voltages to source lines of the display panel 220, and a gate driver that scans gate lines of the display panel 220. The display memory 208 may store display data, received from a Host controller, in units of one frame. The display memory 208 may be referred to as a frame buffer. The power generator 206 may generate source voltages used by the display driving circuit DDI. The power generator 206 may also generate the source voltages used by the touch controller TC. The display control logic 207 may control an overall operation of the display driving circuit DDI.

As illustrated in FIG. 24, the touch controller TC and the display driving circuit DDI may transmit or receive at least one piece of information, such as timing information or status information therebetween. Also, the touch controller TC and the display driving circuit DDI may transmit or receive the source voltages therebetween.

As described above with reference to FIG. 20, the touch controller TC may set, as a masking period of a masking signal MS, a polarity conversion period of a common voltage VCOM or a period where data signals are applied to the display panel DP. The touch controller TC may set the masking period of the masking signal MS, based on the timing information supplied from the display driving circuit DDI.

In an embodiment, the touch controller TC and the display driving circuit DDI is integrated into one semiconductor chip. In an embodiment, the touch controller TC and the display driving circuit DDI are integrated into separate semiconductor chips and are connected to a transmission channel for transmitting or receiving information therebetween.

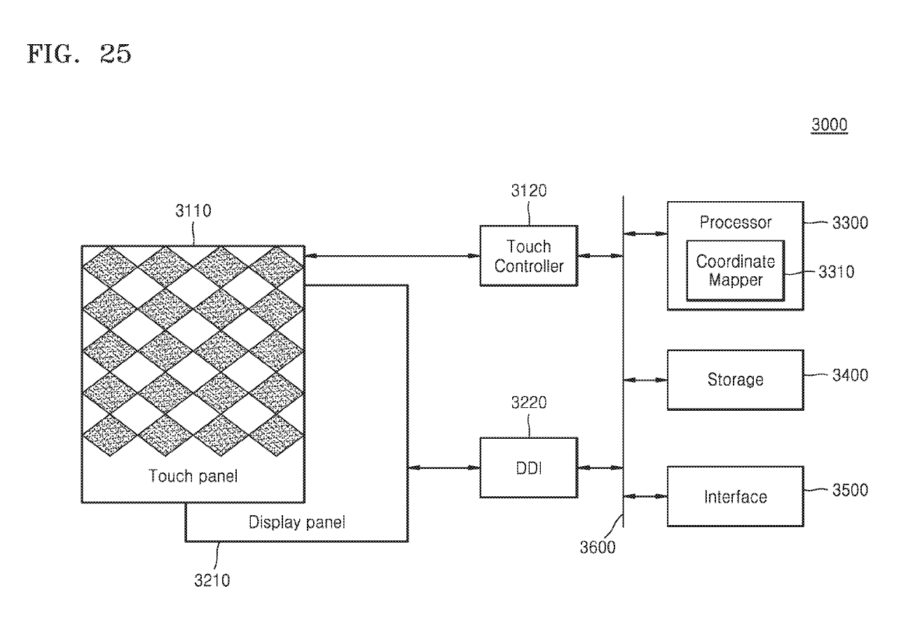

FIG. 25 is a block diagram illustrating a touch screen system 3000 according to an exemplary embodiment of the inventive concept.

The touch screen system 3000 includes a touch panel 3110, a display panel 3210, a touch controller 3120, a display driving circuit 3220, a processor 3300, a storage device 3400, an interface 3500 (e.g., interface circuit), and a bus 3600.

The touch panel 3110 may be configured to sense a touch input applied to each of a plurality of sensing nodes. The display panel 3210 may be configured as various types of panels such as LCDs, LEDs, or OLEDs configured to display an image. The touch panel 3110 and the display panel 3210 may be configured as one body to overlap each other.

The touch controller 3120 may control an operation of the touch panel 3110 and may transmit an output of the touch panel 3110 to the processor 3300. The touch controller 3120 may be a touch controller (100 of FIG. 1) according to the above-described embodiment. The touch controller 3120 may mask some pulses of a periodic pulse signal having a predetermined frequency to generate a driving signal and may sense a touch input applied to the touch panel 3110, based on the driving signal.

The display driving circuit 3220 may control the display panel 3210 to display an image on the display panel 3210. The display driving circuit 3220 may include a source driver, a grayscale voltage generator, a gate driver, a timing controller, a power supply, and an image interface. Image data which is to be displayed on the display panel 3210 may be stored in a memory through the image interface, and grayscale voltages generated by the grayscale voltage generator may be converted into analog signals. The source driver and the gate driver may drive the display panel 3210 in response to a vertical synchronization signal and a horizontal synchronization signal supplied from the timing controller.

The processor 3300 may execute commands and may control an overall operation of the touch screen system 3000. A program code or data desired by the processor 3300 may be stored in the storage device 3400. The interface 3500 may communicate with an arbitrary external device and/or system.

The processor 3300 may include a coordinate mapper 3310. A position in the touch panel 3110 and a position in the display panel 3210 may be mapped to each other, and the coordinate mapper 3310 may extract correspondence coordinates of the display panel 3210 corresponding to a touch point of the touch panel 3110 to which a touch input is applied. By mapping coordinates of the touch panel 3110 and the display panel 3210, a user may select an icon, a menu item, an image, or the like displayed on the display panel 3210 and may perform an input action such as a touch operation, drag, pinch, stretch, a single or multi touch operation, or the like.

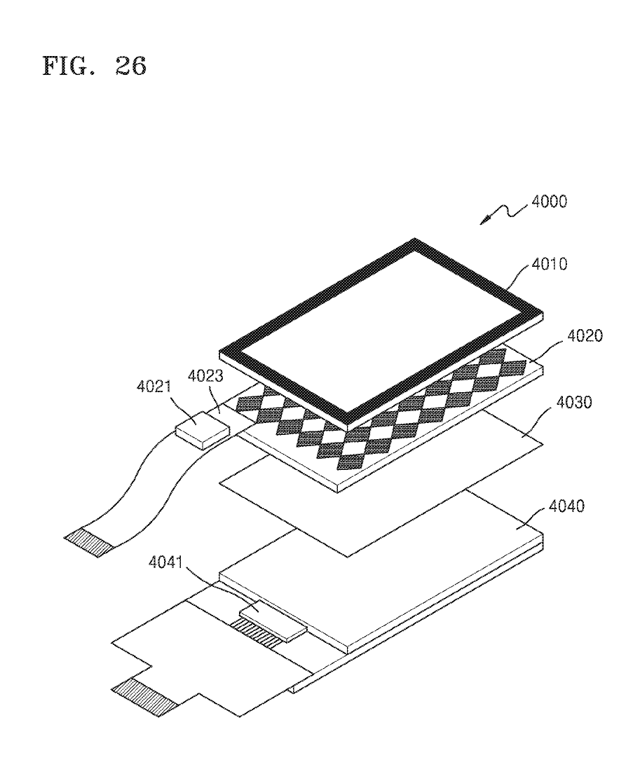

FIG. 26 is a diagram illustrating a touch screen module 4000 including a touch sensing device according to an exemplary embodiment of the inventive concept.

Referring to FIG. 26, the touch screen module 4000 includes a window 4010, a touch panel 4020, and a display panel 4040. Also, a polarizer 4030 may be disposed between the touch panel 4020 and the display panel 4040, for improving optical characteristics.

The window 4010 may be manufactured with a material such as acryl, tempered glass, or the like and may protect the touch screen module 4000 from a scratch caused by an external impact or a repeated touch.

The touch panel 4200 may be formed by patterning a transparent electrode, such as indium tin oxide (ITO) or the like, on a glass substrate or a polyethylene terephthalate (PET) film.

The touch controller 4021 may be mounted on a flexible printed circuit board (FPCB) in a chip-on board (COB) type. The touch controller 4021 may sense a touch applied to the touch panel 3400 to extract touch coordinates and may supply the touch coordinates to a host controller.

The display panel 4040 may be formed by bonding two pieces of glass, namely, an upper substrate and a lower substrate. The display panel 4040 may include a plurality of pixels for displaying a frame. According to an embodiment, the display panel 4040 is a liquid crystal panel. However, the present embodiment is not limited thereto, and the display panel 4040 may include various kinds of display elements. For example, the display panel 4040 may be one of an organic light emitting diode (OLED) display, an electrochromic display (ECD), a digital mirror device (DMD), an actuated mirror device (AMD), a grating light value (GLV) display, a plasma display panel (PDP), an electroluminescent display (ELD), a light emitting diode (LED) display, and a vacuum fluorescent display (VFD).

The display driving circuit 4041, as illustrated, may be mounted on a printed board including a glass material in a chip-on glass (COG) type. However, this is merely an embodiment, and the display driving circuit 4041 may be mounted in various types such as a chip-on film (COF) type, a chip-on board (COB) type, etc. In the present embodiment, the display driving circuit 3130 is illustrated as one chip, but this is merely for convenience of illustration. In other embodiments, the display driving circuit 3130 may be mounted as a plurality of chips. Also, the touch controller 4021 may be integrated into one semiconductor chip along with the display driving circuit 4041.

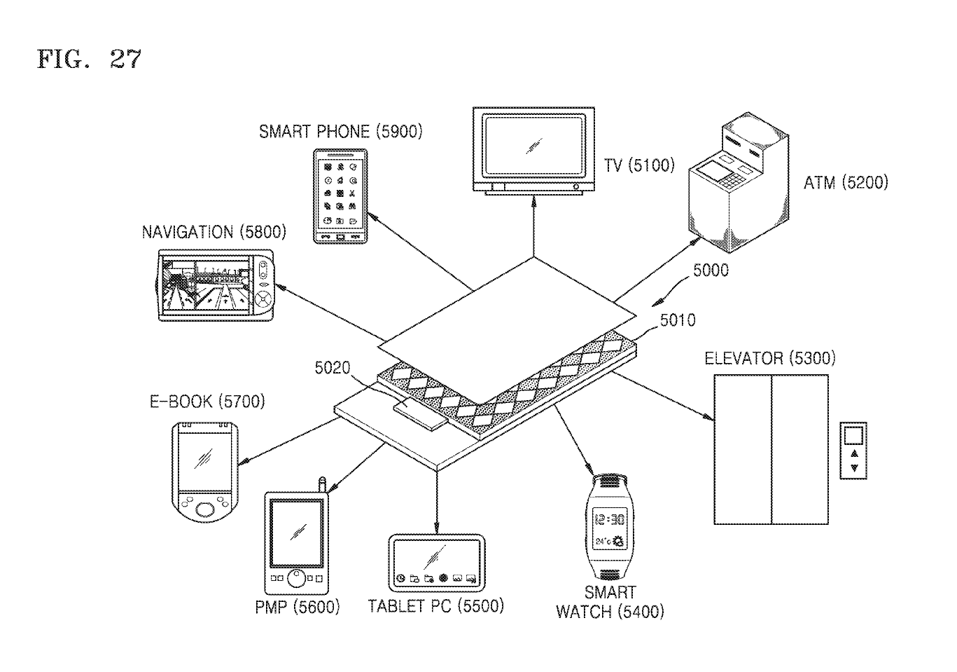

FIG. 27 is a diagram illustrating an application example of various electronic devices each including a touch sensing device 5000 according to an exemplary embodiment of the inventive concept. The touch sensing device 5000 according to an embodiment may be applied to various electronic devices including an image display function. For example, the touch sensing device 5000 may be applied to a smartphone 5900, and moreover, may be widely applied to a television (TV) 5100, an automated teller's machine (ATM) 5200, an elevator 5300, a smart watch 5400, a tablet personal computer (PC) 5500, a PMP 5600, an e-book 5700, and a navigation device 5800.

In addition, the touch sensing device 5000 may be applied to various electronic devices. For example, the electronic devices may be a smartphone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, a wearable device (e.g., a head-mounted device (HMD), electronic clothes, electronic braces, an electronic necklace, an electronic appcessory, an electronic tattoo, or a smart watch), and/or the like.

According to some embodiments, the touch sensing device 5000 may be applied to a smart home appliance including an image display function. The smart home appliance may be, for example, a television, a digital video disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to some embodiments, the touch sensing device 5000 may be a medical device (e.g., magnetic resonance angiography (MRA) device, a magnetic resonance imaging (MRI) device, computed tomography (CT) device, an imaging device, or an ultrasonic device), a navigation device, a global positioning system (GPS) receiver, an event data recorder (EDR), a flight data recorder (FDR), an automotive infotainment device, a naval electronic device (e.g., naval navigation device, gyroscope, or compass), an avionic electronic device, a security device, an industrial or consumer robot, an automation teller's machine (ATM), a point of sale (POS) system, and/or the like.

While the inventive concept has been particularly shown and described with reference to embodiments thereof, it will be understood that various changes in form and details may be made therein without departing from the spirit and scope of the disclosure.

1. A touch controller comprising:
a driving circuit configured to mask some pulses of a first pulse signal having a certain frequency to generate a second pulse signal, and supply the second pulse signal to a touch panel as a driving signal; and
a sensing circuit configured to receive a sensing signal generated by the touch panel based on the driving signal and generate touch data, based on the sensing signal.

2. The touch controller of claim 1, wherein the driving circuit masks the some pulses by suppressing a number of the pulses of the first pulse signal, based on a predetermined number of pulses.

3. The touch controller of claim 1, wherein
the driving signal is supplied to at least one driving channel of the touch panel during a unit period, and
a number of pulses of the second pulse signal per the unit period is smaller than a number of pulses of the first pulse signal per the unit period.

4. The touch controller of claim 1, further comprising: control logic configured to supply masking information to the driving circuit.

5. The touch controller of claim 4, wherein the masking information comprises a masking signal indicating a masking period or number of pulses masked during a unit period from among the pulses of the first pulse signal.

6. The touch controller of claim 5, wherein the number of the pulses masked during the unit period is set based on electromagnetic interference characteristic occurring when the driving signal is supplied to the touch panel.

7. The touch controller of claim 1, wherein the driving circuit comprises:
a periodic signal generator configured to generate the first pulse signal; and
a signal modulation circuit configured to mask the some pulses of the first pulse signal, based on masking information.

8. The touch controller of claim 7, wherein the signal modulation circuit receives the first pulse signal and the masking information and periodically masks the pulses of the first pulse signal, based on the masking information.

9. The touch controller of claim 7, wherein the signal modulation circuit inverts a phase of the first pulse signal or a phase of a signal generated by masking the some pulses of the first pulse signal, based on phase information.

10. The touch controller of claim 7, wherein the signal modulation circuit comprises:
a first signal modulator configured to mask P number of pulses among M number of pulses of the first pulse signal and shift a phase of a signal generated through the masking, based on first masking information and first phase information; and
a second signal modulator configured to mask K number of pulses among the M pulses of the first pulse signal and shift a phase of a signal generated through the masking, based on second masking information and second phase information,
wherein P is an integer less than M, M is an integer greater than or equal to three, and K is an integer less than P.

11. The touch controller of claim 10, wherein a first driving signal output from the first signal modulator and a second driving signal output from the second signal modulator are respectively supplied to a first drive electrode and a second drive electrode of the touch panel.

12. The touch controller of claim 11, wherein
the first driving signal and the second driving signal are simultaneously supplied to the first drive electrode and the second drive electrode, respectively, and
a phase of a certain period of the first driving signal differs from a phase of a certain period of the second driving signal.

13. The touch controller of claim 7, wherein
the periodic signal generator switches between application of a first source voltage and a second source voltage to generate the first pulse signal, based on the certain frequency, and
a level of the first source voltage is higher than a level of the second source voltage.

14. The touch controller of claim 1, wherein
the driving circuit supplies a first driving signal to a first drive electrode of the touch panel and supplies a second driving signal to a second drive electrode of the touch panel, and
a number of pulses of the first driving signal is larger than number of pulses of the second driving signal.

15. The touch controller of claim 14, wherein
the sensing circuit is disposed on one side of the touch panel, and
a distance between the first drive electrode and the sensing circuit is relatively longer than a distance between the second drive electrode and the sensing circuit.

16. A touch sensing device comprising:
a touch panel including a plurality of channels for sensing a touch input; and
a touch controller configured to mask some pulses of a periodic pulse signal having a certain frequency to generate a driving signal applied to the plurality of channels, and sense a capacitance variation rate of each of a plurality of sensing nodes respectively connected to the plurality of channels.

17. The touch sensing device of claim 16, wherein the touch controller comprises:
a driving circuit configured to generate a first driving signal and a second driving signal, based on the periodic pulse signal and respectively supply the first driving signal and the second driving signal to a first channel and a second channel from among the plurality of channels in a first driving period, a number of pulses of the first driving signal differing from a number of pulses of the second driving signal;
a sensing circuit configured to receive sensing signals based on the first and second driving signals and convert the sensing signals into first and second touch data, in the first driving period; and
control logic configured to sense a capacitance variation rate of each of first and second sensing nodes respectively connected to the first and second channels, based on the first and second touch data.

18. The touch sensing device of claim 17, wherein
the driving circuit generates the first driving signal and the second driving signal, based on a masking signal and a phase signal supplied from the control logic, and
the control logic decodes and compensates for the first and second touch data, based on a number of masking pulses included in the masking signal and the phase signal.

19. The touch sensing device of claim 17, wherein
in a first period of the first driving period, a phase of the first driving signal is the same as a phase of the second driving signal, and
in a second period of the first driving period, the phase of the first driving signal differs from the phase of the second driving signal.

20. The touch sensing device of claim 16, wherein
the touch panel is disposed adjacent to a display panel, and
the touch controller masks the some pulses in a time period when data signals are supplied to the display panel.

21-29. (canceled)
